(19) United States
(12) Patent Application Publication
(10) Pub. No.: US 2024/0328201 A1
(43) Pub. Date: Oct. 3, 2024

(54) Touch Bar

(71) Applicant: Surelock McGill Limited, Wokingham (GB)

(72) Inventor: Glen Davies, Reading (GB)

(21) Appl. No.: 18/621,347

(22) Filed: Mar. 29, 2024

(30) Foreign Application Priority Data
Mar. 29, 2023 (GB) 2304584.2
Jan. 19, 2024 (GB) 2400755.1

(51) Int. Cl. E05B 47/00; E05B 65/10; F16D 63/00; F16D 65/16; F16D 121/20; F16H 25/20; F16H 25/24; H02K 7/106

(52) U.S. Cl. CPC E05B 47/0012; E05B 65/1053; E05B 65/1086; F16D 63/002; F16D 63/006; F16D 65/16; F16H 25/20; F16H 25/2454; H02K 7/106; E05B 2047/0017; E05B 2047/0023; F16D 2121/20; F16H 2025/2075

(57) ABSTRACT

There is provided a touch bar assembly for releasing a bolt, the touch bar assembly comprising: a touch bar for actuation by a user; an action slider coupled to the touch bar for retracting the bolt; a motor arranged to drive a linear actuator between a retracted position, a neutral position and a blocking position, the linear actuator coupled to the action slider by a coupling, wherein the linear actuator and coupling are configured such that in the blocking position retraction of the action slider is blocked, and the coupling couples motion of the linear actuator from the neutral position to the retracted position into retraction of the action slider to retract the bolt. There may also be provided a motor assembly with brake.

This application claims priority to United Kingdom application number 2304584.2, filed Mar. 29, 2023, and United Kingdom application number 2400755.1, filed Jan. 19, 2024, the disclosures of which are incorporated herein by reference in their entirety.

### TECHNICAL FIELD

The present invention relates to a touch bar assembly for releasing a bolt that secures a door. In particular, the touch bar assembly may be fitted with single or multi-point bolting mechanisms for securing and permitting release of emergency exit doors. The touch bar assembly may also be known as a panic bar assembly or panic exit device.

### BACKGROUND

Emergency exit doors on buildings often include an emergency release mechanism, such as a touch bar or touch bar assembly, or push pad, on the face of the door inside the building. FIG. 1 shows such a touch bar assembly 20 on door 10. The touch bar assembly 20 is coupled to a bolting mechanism 30 which actuates one or more bolts to secure the door. In the arrangement of FIG. 1 three bolts 40 are included (only two are shown) which engage in keeps or strike plates 50 at or in the door frame or floor. In FIG. 1 the door is shown as may be seen on the inside of the building and is hinged on side 60, opening in the direction of arrow B with an opening side 65. When pushed, such as in the direction of arrow A, the touch bar of the touch bar assembly releases the one or more bolts from positions in which the bolts secure the door closed to released positions in which the door is free to open. The use of touch bars or push pads is to allow rapid exit from a building in emergency situations while maintaining the door secured from the outside. Touch bars provide a visible means for releasing the door because they often extend across the whole width of the door or a significant portion thereof. Touch bars are considered to provide faster release of the door than a conventional door handle because the touch bar is easier to identify and actuation is a simple pushing action. Conversely, door handles are more difficult to locate, especially if the lighting is poor in the emergency situation where smoke may be present, and it may not be clear which way it is required to turn the door handle to release the bolts. The result is that touch bars are often preferred on emergency exit doors.

However, the ease and speed with which emergency exit doors may be opened may also cause security problems from inside the building. For example, large shops and stores may include emergency exit doors to allow escape from the building by anyone who requires a rapid escape. Thieves and persons stealing goods from stores may use the touch bar to quickly escape from the store with goods. In some stores the emergency exit doors may not be alarmed and by leaving through the emergency exit doors the thieves may avoid security personnel on the main entrance doors to the store. Hence, it is desirable to limit egress from emergency exit doors when there is not an emergency. One such way is to include a time delay on the touch bar assembly.

U.S. Pat. No. 5,011,199 describes a panic exit device having an exit delaying mechanism. The mechanism obstructs movement of a linkage coupled to a latchbolt. The latchbolt is manually actuated by a push pad and includes an arm which normally pivots to actuate the linkage. An initial, limited movement of the linkage actuates a switch. The switch activates a time delay, which after a specified time interrupts power to a solenoid. The solenoid, when normally powered, forces a rod carrying a roller into the path of the linkage preventing full movement of the arm and retraction of the latchbolt. When de-energized, the rod and roller are retracted permitting pivoting movement of the arm and movement of the latchbolt to its unlatched position. U.S. Pat. No. 5,085,475 describes a similar exit delaying mechanism for a panic exit device.

Recently it has become desirable to enable access through doors, including emergency exit doors, to be controlled with access control systems that provide electronic control, such as based on user authorisation or time of day etc. Prior art methods have been made to incorporate access control into touch bars for emergency exit doors. For example, the access control system may operate in delayed exit mode during the hours a shop or store is open for sales, but may also provide access through the door for users having authorization, such as employees carrying an access control card (swipe card). A prior art door exit device is described in U.S. Pat. No. 7,536,885 B1 which includes manual egress, delayed egress and motorised egress such as is compatible with an access control system. However, such a device is complex and is not easily added or the functionality changed or upgraded once the door exit device has been fitted to a door. It may also be desirable that the door and exit device be able to withstand significant force preventing egress even when the force on the exit device becomes large.

### SUMMARY OF THE INVENTION

The present invention provides a touch bar assembly for releasing a bolt, the touch bar assembly comprising: a touch bar for actuation by a user; an action slider coupled to the touch bar for retracting the bolt; a motor arranged to drive a linear actuator between a retracted position, a neutral position and a blocking position, the linear actuator coupled to the action slider by a coupling, wherein the linear actuator and coupling are configured such that in the blocking position retraction of the action slider is blocked, and the coupling couples motion of the linear actuator from the neutral position to the retracted position into retraction of the action slider to retract the bolt. The action slider may comprise the coupling. The motor in combination with the linear actuator sets in which of three modes the touch bar assembly is operating, namely: blocking retraction of the one or more bolts, permitting retraction of the one or more bolts, and motorised retraction of the one or more bolts. Preferably, the motor and electromagnet are the only components drawing electrical power that provides selection between the modes. Additionally, the motorised function allows delayed egress to be performed. The motor, linear actuator and coupling to the action slider are located at one end of the touch bar assembly. This allows the motor and associated functionality to be retrofitted to an existing touch bar assembly already deployed on a door, thereby allowing later existing touch bars to be upgraded.

The touch bar assembly may be configured such that movement of the linear actuator from the blocking position to the neutral position may release the action slider for retraction of the bolt.

The coupling and linear actuator may be configured with lost motion there between such that, when the linear actuator is at the neutral position, movement of the action slider by actuation of the touch bar does not move the linear actuator.

The motor may comprise a spindle having at least a threaded portion and the motor may be configured to rotate the spindle and rotation of the spindle drives movement of the linear actuator.

The linear actuator may comprise a threaded hole portion and the linear actuator may be arranged to move along a linear path when the motor rotates the spindle.

The coupling may comprise one or more guides or slots into which the linear actuator extends for guiding or blocking retraction of the bolt.

The touch bar assembly may further comprise one or more brakes to stop or block rotation of the spindle of the motor.

A first brake of the one or more brakes may comprise: an electromagnet; a rotor coupled to the spindle for rotation with the spindle, the rotor being ferromagnetic and having first teeth; and second teeth fixedly arranged facing the first teeth in an axial direction of the motor, wherein the brake is arranged such that on energising or de-energising the electromagnet the rotor is pulled towards the second teeth and the first teeth engage with the second teeth stopping rotation of the rotor and spindle.

The rotor may be biased away from the second teeth. In this way the electromagnet may be arranged such that, for example, when it is de-energised the rotor rotates freely.

The electromagnet may be annular and may be arranged with the spindle passing there through. Second teeth may be arranged on a tubular sleeve around the electromagnet.

The first teeth and/or second teeth may be formed with sides at an angle of between 35 and 55°, or more preferably between 40 and 50°, such as at 45°. By sides of the teeth we mean sides in the circumferential direction.

The motor may be a stepper motor comprising a second brake which is provided by the fields of the coils within the motor.

The action slider may be coupled to the touch bar by cranks, and the cranks may be configured such that on pushing the touch bar the cranks rotate to translate the action slider.

The action slider may comprise a receiving portion coupled to the touch bar to receive a driving force from a user applied at the touch bar. The action slider may further comprise a transmitting portion coupled to the coupling for movement by the linear actuator, and wherein the action slider may comprise one of more safety springs between the receiving portion and transmitting portion, the safety springs arranged to absorb the user force when the linear actuator is in the blocking position.

The touch bar assembly may further comprise the bolt or a bolting mechanism including the bolt. The bolting mechanism may be a single or multi-point bolting mechanism.

The present invention further provides a door comprising the touch bar assembly set out in the preceding paragraphs.

The present invention further provides a motor assembly with brake, the assembly comprising: the motor having a spindle; and the brake comprising: an electromagnet; a rotor coupled to the spindle for rotation with the spindle, the rotor being ferromagnetic and having first teeth; and second teeth fixedly arranged, the second teeth facing the first teeth in an axial direction of the motor, wherein the brake is arranged such that on energising or de-energising the electromagnet the rotor is pulled towards the electromagnet and the first teeth engage with the second teeth stopping rotation of the rotor and spindle.

The spindle may extend from a first side of a motor for rotational driving to a second side of the motor where the rotor is coupled to the spindle.

The teeth may be formed in at least part of a circle in proximity to the electromagnet.

The electromagnetic may be arranged around the spindle at the second side of the motor.

The rotor may be a disc. The second teeth may be arranged around a circumference of the electromagnet.

The motor assembly may further comprise a tube, pipe or sleeve around the electromagnet and the second teeth may be arranged at the end of the tube or pipe.

The first teeth and/or second teeth may be formed with sides at an angle of between 35 and 55°, or more preferably between 40 and 50°, such as at 45°. By sides of the teeth we mean sides in the circumferential direction.

The teeth may be formed by casting or machining, or more preferably by stamping or pressing.

The motor may be a stepper motor. The brake is a first brake and the stepper motor may comprise a second brake.

The spindle may be a rod having at least a portion that is threaded extending from the first side of the motor.

The motor assembly may further comprise a linear actuator having a threaded hole, the threaded portion of the spindle arranged to extend therethrough, and the linear actuator arranged such that on rotation of the spindle the linear actuator moves linearly.

The present invention further provides a method of manufacturing a motor assembly with brake, the method comprising: providing a motor with a spindle, stamping or pressing teeth into the end face of a sleeve; stamping or pressing teeth into a rotor; fitting the sleeve around the electromagnet; fixing the electromagnet to the motor; and fitting the rotor to the spindle.

The present invention provides a second embodiment of a touch bar assembly for releasing a bolt. The second embodiment of touch bar assembly comprises: a touch bar for actuation or pushing by a user; an action slider or action bar coupled to the touch bar for retracting the bolt; a motor arranged to drive a motor rod between a retracted position, a neutral position and a blocking position, the motor rod coupled to the action slider by a coupling comprising a gate, wherein movement of the motor rod from the neutral position to the blocking position moves the gate to a blocking configuration blocking retraction of the action slider, and the coupling couples motion of the motor rod from the neutral position to the retracted position into retraction of the action slider to retract the bolt. The action slider may be a bar or rod or may take other shapes such as comprising cut-outs to accommodate springs. The motor in combination with the motor rod sets in which of three modes the touch bar assembly is operating, namely: blocking retraction of the one or more bolts, permitting retraction of the one or more bolts, and retracting the one or more bolts. Preferably, this single motor is the only component drawing electrical power that provides movement for selection between the modes. Additionally, the motorised function allows delayed egress to be performed. The motor, motor rod and coupling to action slider are located at one end of the touch bar assembly. This allows the motor and associated functionality to be retrofitted to an existing touch bar assembly already deployed on a door, thereby allowing later existing touch bars to be upgraded.

The movement of the motor rod from the blocking position to the neutral position may move the gate to an open position releasing the action slider for manual or motorised retraction of the bolt.

The motor may comprise a brake to prevent movement (up to a limit) of the motor rod when in the blocking position.

The gate may be arranged such that in the blocking configuration, the gate reduces a user force transmitted from the action slider to the motor rod. The combination of the gate and the motor brake resists movement of the action slider, preventing egress.

The gate may comprise a stopping bar, and the gate may be configured such that in the blocking configuration the stopping bar blocks movement of the action slider. For example, by blocking or sitting in its path.

The stopping bar may slide in a slot and may be biased away from a blocking configuration, that is towards an unblocked configuration. The action slider may be configured to move in a first direction as its retracts the bolt. The slot may restrict the direction of movement of the stopping bar and may be angled to be less than 90° transverse to the movement direction of the action slider. The slot may be angled between 60 and 85°, or more preferably between 70° and 80°, or even more preferably around 75°, transverse to the movement direction of the action slider. The angle of the slot may be used to determine how much force applied by user at the touch bar is passed on to the motor. This in combination with safety springs prevents the motor brake from being overcome and the motor from being damaged.

The action slider may comprise a blocking surface against which the stopping bar bears in the blocking configuration.

The coupling may comprise a carriage coupled to the motor rod and the action slider. The carriage may have a driving surface arranged such that on moving the motor rod to the blocking position the driving surface bears against the stopping bar to move the gate, or stopping bar, to a blocking configuration. The driving surface may be a ramp or sloping surface arranged to pull the stopping bar down to block retraction of the action slider as the motor rod pushes the carriage and moves to the blocking position.

The ramp or sloping surface may have an angle of between 25° and 55° to the movement direction of the action slider. The ramp or sloping surface may have an angle of between 30° and 40°, or more preferably around 35° to the movement direction of the action slider.

The carriage may couple motion of the motor rod from the neutral position to the retracted position to pull on the action slider to retract the bolt.

The coupling may be configured with lost motion between the carriage and the action slider such that movement of the action slider by actuation of the push pad does not move the motor rod. The lost motion may be provided by a rod of the carriage moving in a slot of the action slider.

The carriage may comprise a channel in which the action slider extends.

The motor rod may be biased from the blocking position to the neutral position. For example, such that when power is lost the motor rod moves to the neural position ready for manual retraction of the bolt.

The action slider may be coupled to the touch bar by cranks. The cranks may be configured such that on pushing the touch bar the cranks rotate to translate the action slider.

The action slider may comprise a receiving portion coupled to the touch bar to receive a driving force from a user applied at the touch bar, and may comprise a transmitting portion coupled to the coupling for movement by the motor rod. The action slider may comprise one of more safety springs between the receiving portion and transmitting portion, the safety springs arranged to absorb, such as by compressing, the user force when the gate is in the blocking configuration.

The one or more safety springs may be configured to absorb a user force to protect the mechanism and motor. By protecting the mechanism, parts of the mechanism do not become bent or damaged and even under high user force reliable operation of the touch bar is maintained, as required for a safety device.

The safety springs may compress until the touch bar bottoms out (fully depressed) so that extra force does not push it any further. The stopping bar and motor brake may maintain their position, preventing egress. In delayed egress mode, with a sensor monitoring for touch bar movement, by partially and then fully depressing the touch bar, a controller may be alerted and a timer begins to countdown. When this time period expires the motor rod may be powered back in a controlled manner pulling the coupling to the neutral position. The load of the safety springs will force the action slider to push the stopping bar clear, allowing egress. Alternatively, when the time period expires power is removed from the motor entirely releasing its brake. The bias springs pull the motor rod and coupling towards the neutral position and the load of the safety springs will force the action slider to push the stopping bar clear, allowing egress.

The touch bar may further comprise the bolt or a bolting mechanism including the bolt.

The present invention also provides a door or opening comprising the touch bar assembly set out herein.

### BRIEF DESCRIPTION OF THE DRAWINGS

Embodiments of the present invention, and aspects of the prior art, will now be described with reference to the accompanying drawings, of which:

FIG. 1 is a perspective schematic drawing of a door with a prior art touch bar assembly fitted;

FIG. 2 is a perspective drawing of a touch bar assembly according to an embodiment of the present invention;

FIGS. 3A-3D are schematic diagrams of various stages of the operation of the touch bar assembly according to embodiments of the present invention;

FIG. 4 is a block diagram showing the relation between components of the touch bar assembly of FIG. 3;

FIG. 5A is a plan view of the touch bar assembly and FIGS. 5B and 5C are side cross-sectional views of the touch bar assembly respectively taken at a centreline and close to the outer lateral housing;

FIGS. 6A and 6B are side cross-sectional views of the touch bar assembly taken at a centreline, respectively showing the touch bar in the thrown and depressed positions with a blocking action causing compression of safety springs, FIGS. 6C and 6D are enlarged views of portions of FIGS. 6A and 6B;

FIGS. 7A-7D respectively are a perspective view, plan view, side view and side cross-sectional view of the components controlling the blocking and retraction functions of the touch bar assembly;

FIGS. 8A and 8B are side cross-sectional views of the touch bar assembly taken at a centreline, showing the touch bar in the thrown position and respectively showing the motor rod and other components in the neutral position and the blocking configuration, FIGS. 8C and 8D are enlarged views of portions of FIGS. 8A and 8B;

FIGS. 9A and 9B are side cross-sectional views of the touch bar assembly taken at a centreline, respectively showing the touch bar in the thrown and retracted positions, with the touch bar having been retracted manually, FIGS. 9C and 9D are enlarged views of portions of FIGS. 9A and 9B;

FIGS. 10A and 10B are side cross-sectional views of the touch bar assembly taken at a centreline, respectively showing the touch bar in the thrown and retracted positions, with the touch bar having been retracted by the motor, FIGS. 10C and 10D are enlarged views of portions of FIGS. 10A and 10B;

FIGS. 11A-11C show components controlling the blocking and retraction functions during steps of egress, from blocking to retracted positions, when power to the motor is removed or lost, in side view and cross-sectional view;

FIGS. 12A-12D show components controlling the blocking and retraction functions during steps of egress, from blocking to retracted positions, when a load is continuously applied to the touch bar and power to the motor is removed or lost, in side view and cross-sectional view;

FIGS. 13A and 13B are side and top plan views of the interface between the touch bar and a bolting mechanism;

FIG. 14 is a flow diagram showing the different operation steps of the touch bar assembly;

FIG. 15 is a perspective view of an alternative embodiment of a motor and coupling arrangement for setting the operating mode of the touch bar assembly;

FIG. 16 is an exploded perspective view of motor and brake of FIG. 15;

FIG. 17A is an exploded perspective view of linear actuator and FIG. 17B is a cross-sectional view through the linear actuator;

FIGS. 18A and 18B are respectively top plan and side sectional views of the motor and brake with brake released, and FIGS. 18C and 18D are respectively top plan and side sectional views of the motor and brake with brake activated;

FIG. 19 comprises a top plan view and a side view of the motor with brake, with the action slider thrown and the linear actuator in the neutral position;

FIG. 20A comprises a top plan view and FIG. 20B a side view of the motor with brake, with the action slider and coupling in the retracted position;

FIG. 21A comprises a top plan view and FIG. 21B a side view of the motor with brake, with the linear actuator in the blocking position and the brake released;

FIG. 22A comprises a top plan view and FIG. 22B a side view of the motor with brake, with the linear actuator in the blocking position and the brake applied;

FIG. 23A comprises a top plan view and FIG. 23B a side view of the motor with brake, with the linear actuator in the neutral position and the action slider thrown; and

FIG. 24A comprises a top plan view and FIG. 24B a side view of the motor with brake, with the action slider and coupling moved to the retracted position by operation of the motor.

### DETAILED DESCRIPTION

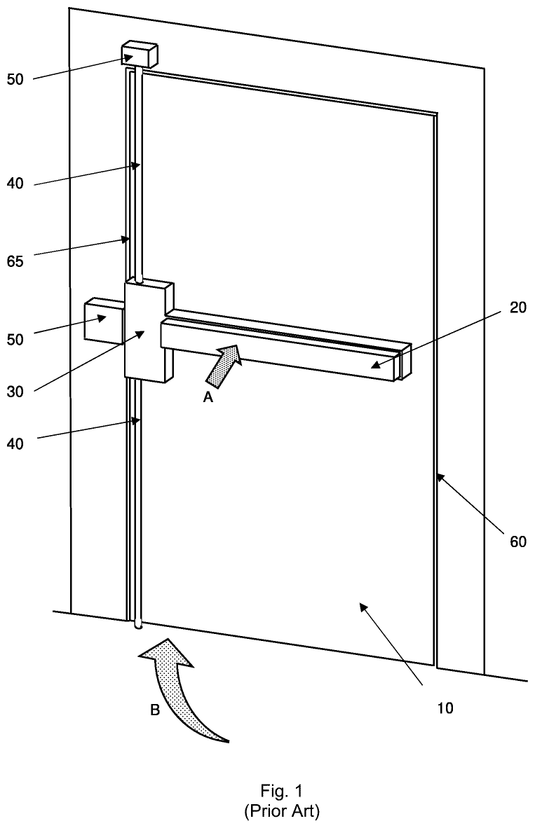

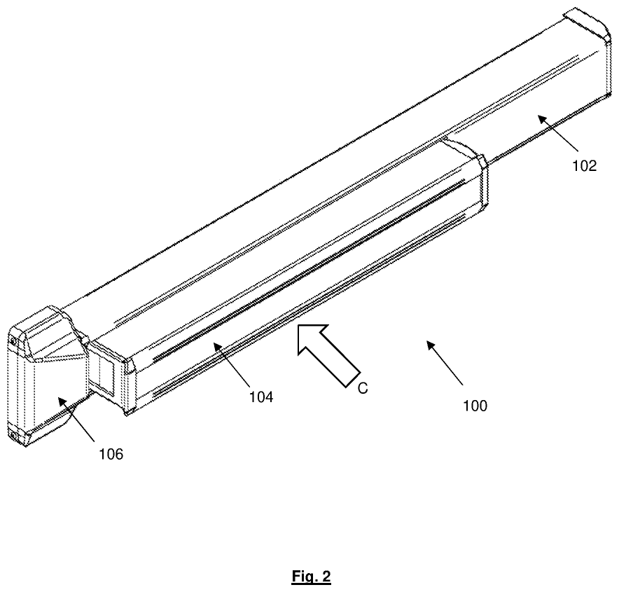

FIG. 2 is a perspective view of a touch bar assembly 100 according to the present invention. The touch bar assembly may be fitted to a door in a similar way to that shown in FIG. 1. The touch bar assembly 100 comprises a base housing 102 and a touch bar 104. The base housing may be an elongate rectangular housing, that may have a width no greater than the width of a door. The assembly also comprises a touch bar 104. The touch bar 104 is an actuatable part of the assembly. The touch bar 104 may extend the full width or part of the width of the base housing 102. For example, as shown in FIG. 2 the touch bar extends to a length greater than half the length of the housing. The touch bar 104 is also rectangular and extends from the front face of the base housing 102. When depressed the touch bar 104 retracts into the base housing 102. The touch bar assembly 100 may also comprise a connection cover 106 which is part of the housing and covers the connection between the mechanism of the touch bar assembly and the bolting mechanism that is operated by the touch bar assembly 100. The bolting mechanism is not shown in FIG. 2 but, for example, may be located behind the connection cover 106 and may drive one or more bolts in a corresponding manner to bolting mechanism 30 in FIG. 1.

Actuation of the touch bar 104 of the assembly 100 is by pushing or depressing the touch bar in the direction shown by arrow C such that it is partly retracted into the base housing. Pushing or depression of the touch bar 104 acts to retracts bolts such as the bolts 40 shown in FIG. 1.

The touch bar assembly 100 according to the present invention may provide functions of manual retraction of one or more bolts and motorised retraction of one or more bolts. Delayed egress may also be included which may be motorised or manually operated. The touch bar assembly of the present invention includes a blocking action that blocks the touch bar from actuating the bolts. This blocking action remains until released by the motor or power to the motor is turned off.

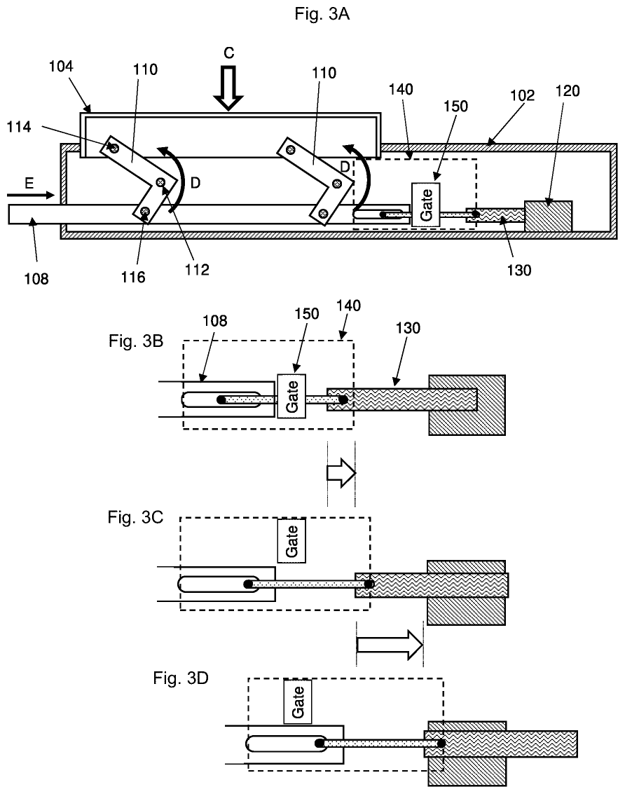

FIGS. 3A-3D are schematic diagrams of the mechanism of the touch bar assembly 100. In FIG. 3A the touch bar assembly can be seen to include base housing 102 and touch bar 104 for depressing by a user in a direction as indicated by arrow C. The touch bar assembly 100 further comprises action slider 108 or action bar which is coupled to the touch bar 104 by a pair of cranks 110. The cranks may be L-shaped cranks. Alternatively, the cranks may be bellcranks or other suitable cranks or arms for providing the required linkage. The cranks are mounted in the housing to rotate about pivot 112. The cranks are connected to the touch bar at pivots 114 towards one end of the L-shape. The cranks are connected at the other end to the action slider 108 at pivots 116 which is at the other end of the L-shape. When the touch bar 104 is pushed in the direction indicated by arrow C the cranks rotate in the direction of arrows D which results in retraction of action slider 108 in the direction of arrow E. By having the touch bar 104 coupled to the action slider 108 by cranks 110 with a pin based pivot and full bearing face, as the touch bar is depressed it may move through a slight arc. Conventional touch bars may move perpendicular to a face of the door without the arc movement. The movement of such conventional touch bars is achieved through a pin in a slot arrangement. The crank and arc movement described herein experiences less friction for a smoother action as compared to conventional touch bars.

The action slider 108 is further connected by a coupling 140 to a motor rod 130 which is moved by a motor 120. The coupling 140 comprises a gate 150 which may be used to control or restrict movement of the action slider 108. Further detail on the coupling 140 and gate 150 is described with reference to FIGS. 3B-3D. The motor rod 130 is moved by motor 120 when controlled to do so and when power is applied to the motor. The motor 120 is arranged to drive the motor rod 130 from a retracted position to a neutral or mid-position and further to a blocking position. The motor 120 is also arranged to reverse the movement of the motor rod 130. FIG. 3B shows the motor rod 130 in a blocking position. With the motor rod in the blocking position the gate 150 is in a blocking configuration. Here the gate 150 blocks retraction of the action slider. As the slider is coupled to a bolting mechanism, the blocking configuration thereby blocks retraction of the bolt or bolts of the bolting mechanism. FIG. 3C shows the motor rod 130 has been moved further by the motor. The motor rod 130 is now at the neutral or mid-position. In this position the gate is moved from the blocking configuration such that it is no longer blocking the path of the action slider 108. The action slider 108 can now be retracted to retract the bolt or bolts of the bolting mechanism. The retraction of the action slider 108 may be by manual depression of the touch bar 104 or may be by further driving of the motor and motor rod. FIG. 3D shows the motor rod has been driven to a retracted position by the motor. As the motor rod is moved by the motor to the retracted position, the coupling 140 couples the retraction of the motor rod to the action slider to retract the action slider. The retraction of the action slider retracts the bolt or bolts of the bolting mechanism. There are various possible mechanisms for the coupling between the motor rod and action slider such that movement of the motor rod to and from the blocking position moves the gate to and from a blocking configuration and also couples movement of the motor rod between the neutral position and the retracted position to movement of the action slider. An embodiment of such a mechanism will be described below.

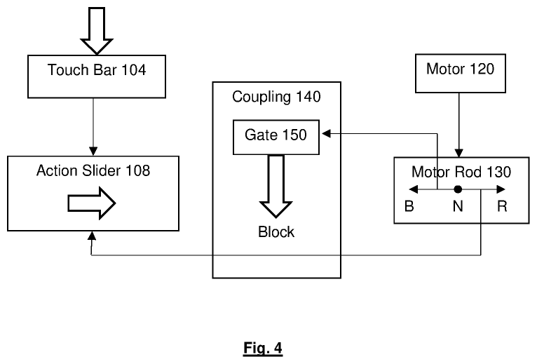

FIG. 4 is a flow chart summarizing the operation of the touch bar assembly of FIG. 3. The position of the motor rod 130, which is driven by the motor 120, provides some control over movement of the action slider 108 and position of the gate 150 of the coupling 140. The motor may move the motor rod 130 from a blocking position (B in FIG. 4) to a neutral position (N in FIG. 4) and further to a retracted position (R in FIG. 4). Movement of the motor rod 130 to the blocking position moves the gate to the blocking configuration. In the blocking configuration retraction of the action slider 108 is blocked. When the gate 150 is not in the blocking configuration the action slider may be retracted either by pushing the touch bar 104 or by driving the motor rod 130 to the retracted position. In the latter case the coupling couples retraction of the motor rod 130 to retraction of the action slider 108. The retraction of the action slider 108 manually or by the motor rod retracts the one or more bolts of the bolting module.

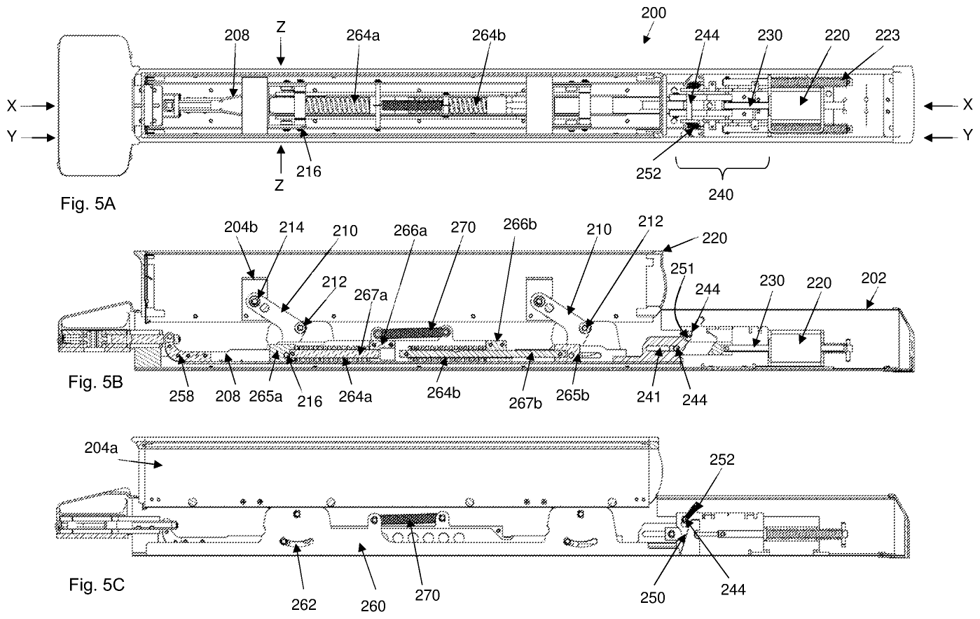

FIGS. 5A-5C show an embodiment of the touch bar assembly 200 according to the present invention. FIG. 5A is a plan view of the touch bar assembly with part of the touch bar 204 and part of the base cover 202 removed such that the mechanism inside can be seen. FIG. 5B is a side view taken as a cross-sectional view at the longitudinal centre line (line X-X) of the touch bar assembly. FIG. 5C is a side view taken as a cross-sectional view along line Y-Y such that the outer lateral housing is not shown. In FIGS. 5A-5C the touch bar is in the thrown or extended position ready to be depressed or pushed such as for emergency egress from a building.

FIG. 5B shows the touch bar 204 of the touch bar assembly. The touch bar 204 comprises an elongate panel or bar that extends along a substantial part of the touch bar assembly 200, such as at least half of the length of the touch bar assembly. Base housing 202 covers some parts of the internal mechanism of the touch bar assembly, such as motor 220. The touch bar 204, when in the thrown position as shown in FIGS. 5A-5C, extends from, that is it sits proud of the base housing 202. The touch bar may be configured as a solid unit, or to save weight may have a hollow part with side faces to shield internal mechanisms. The side faces are shown as 204a in FIG. 5C. The touch bar 204 is coupled to cranks 210. The cranks 210 may be L-shaped or may be bellcranks. Multiple cranks may be provided. For example, in FIG. 5B one is shown towards a first end of the touch bar and the other towards a second, opposing end of the touch bar. As shown in FIG. 5A, four cranks are provided. To support the touch bar across its width two cranks are provided adjacent to each other at each of the longitudinal positions towards the ends of the touch bar. For example, the third and fourth cranks are hidden behind the two cranks shown in FIG. 5B. The cranks are mounted to a base 260 of the assembly by respective pivots 212. Each adjacent pair of cranks are coupled to the touch bar 204 by a U-shaped support 204b. The support 204b spans the width of the touch bar to provide support to its width and is coupled to the side faces of the touch bar by fixings such as screws. The ends of the U-shaped supports 204b include pivots 214 at which the first ends of the cranks are mounted. The base 260 comprises a portion, such as a back plate, for mounting the touch bar assembly to a door. The parts of the base 260 at which the cranks are pivotably mounted are tabs extending transversely away form the back plate to raise the pivot 212 above the back plate such that the crank has space to rotate without the second end colliding with the back plate.

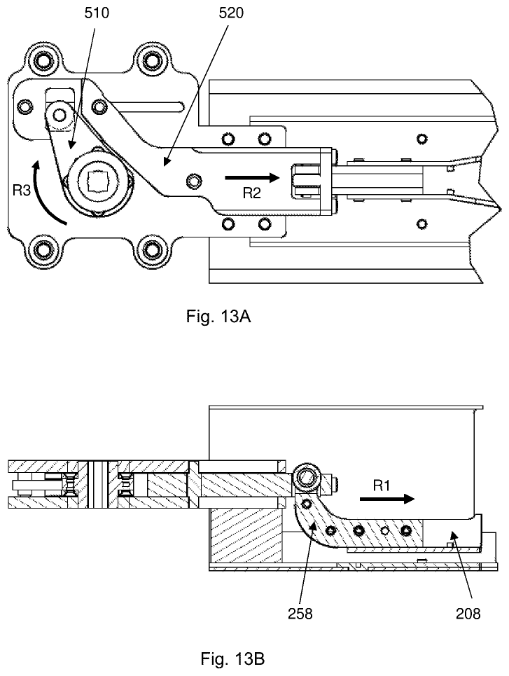

The touch bar assembly 200 further comprises an action slider 208 which may extend along a length of the touch bar assembly similarly to the length of the touch bar. Towards the left hand of FIGS. 5A-5C the action slider 208 can be seen and includes a hooked portion 258 which extends upward, away from the back plate 260 to couple to a component for driving the bolts of the bolting mechanism, as described at FIG. 13. The action slider is coupled to the cranks 210 at pivots 216. As can be seen in FIG. 5C the coupling at pivot 216 may include a fastener. Since the fastener may protrude from the face of the crank and action slider, a slot 262 may be cut in the tab part of the base to accommodate the fastener. As can be seen in FIG. 5C the slot 262 is curved. This is because the rotational movement of the cranks will cause the action slider 208 to move translationally in a slight arc or rocking motion. The hooked portion 258 at the end of the action slider may fit into a hole in the component for connecting to the bolting mechanism. This hook and hole combination accommodates the small rocking motion that accompanies the lateral translation. If a cross-section is taken through the action slider 208 such as at Z-Z in FIG. 5A, the action slider may have a U-shaped cross-section which forms a channel along the slider 208. In this channel may optionally be formed a safety mechanism. The safety mechanism may allow depression of the touch bar even if movement of the action slider is blocked. However, in embodiments the safety mechanism may not be included and in such cases movement of the touch bar is coupled to movement of the action slider.

FIGS. 5A-5C show the safety mechanism which comprises a pair of stiff coiled safety springs 264a, 264b. Although the springs are coiled and two such springs are provided, other types and numbers of springs may be used instead. With the safety mechanism included, the cranks 210 couple via the safety springs to the action slider 208. In FIGS. 5A and 5B the left hand crank is pivotably coupled at 216 to first spring block 265a. First spring block 265a is coupled to the left hand stiff spring 264a. The other end of left hand stiff spring 264a is coupled to first fixing block 266a which is fixed in the channel of the action slider 208. The stiff springs 264a, 264b are compression springs. The direction of movement of the first spring block 265a as the stiff spring 264a is compressed may be guided by a rod 267a along the axis of the spring 264. The rod 267a may pass through a hole in first fixing block 266a.

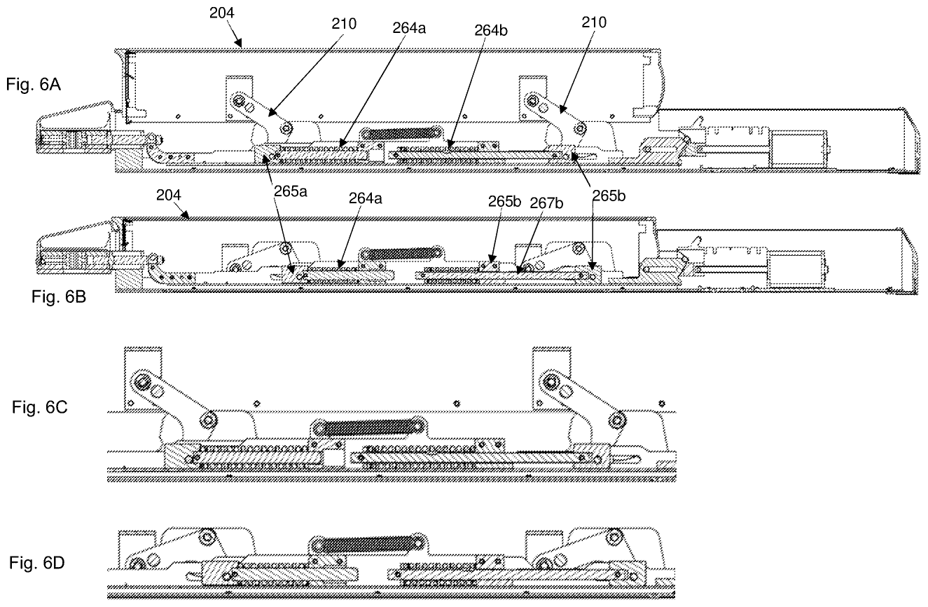

The arrangement of the right hand cranks in FIGS. 5A-5C is similar to the left hand ones but with second stiff spring 264b. The arrangement of the second spring 264b differs from that of the first spring 264a. Here right hand cranks couple to second spring block 265b which is coupled to a rod 267b and rod 267b passes through a hole in second fixing block 266b which is fixed in position in the channel of the action slider. Second spring 264b is coupled between the end of rod 267b and second fixing block 266b. Rod 267b is configured through and along the axis of second spring 264b. When the touch bar is pressed but movement of the action slider is blocked the cranks rotate compressing the safety springs 264a and 264b. As shown in the figures the safety springs may be located in the channel of the action slider 208. We will describe operation of the safety springs in relation to FIG. 6.

Also shown in FIGS. 5A-5C is return spring 270. Return spring 270 acts to return the touch bar 204 to its thrown or start position when user pressure is released. The return spring acts between the touch bar and base 260. One end of return spring 270 is coupled to a rod which sits between a pair of opposing tabs extending from the sides of the base 260. The other end of the return spring is coupled to a rod which sits between a pair of opposing tabs extending from the sides of the action slider 208. The return spring 270 may be a coiled compression spring although other types of spring may be used. When the touch bar is depressed and the action slider moves, the return spring becomes extended. In FIGS. 5A-5C this is because the action slider 208 moves to the right. When the touch bar is released the return spring 270 pulls the action slider back to the start position and the cranks move the touch bar back to the thrown position.

We now describe operation of the safety springs 264a, 264b. FIG. 6A is a cross-section view of the touch bar assembly 200 similar to FIG. 5B showing the touch bar in the thrown position. FIG. 6B shows a corresponding view but with the touch bar in the pressed or retracted position. In FIGS. 6A and 6B the movement of the action slider is blocked so pushing on the touch bar causes the safety springs to compress as we will now describe. FIGS. 6C and 6D respectively also show the touch bar in the thrown and retracted positions but in partial enlarged views. As can be seen in FIGS. 6A and 6C the cranks 210 are each in their start positions with one end of the cranks pointing diagonally upwards to the left. In FIGS. 6A and 6C the safety springs 264 and 264b are shown extended. Turning to FIG. 6B, the touch bar 204 is depressed and the cranks 210 have rotated such that the ends of the cranks are now pointing downwards in the figure. The rotation of left hand crank has caused the first spring block 265a to move compressing left hand spring 264a. Rod 267a can be seen to have been forced further through hole in fixing block 266a. Similarly, the right hand spring 264b has been compressed by movement of spring block 265b to the right by rotation of right hand crank. The spring block 265b has pulled on rod 267b compressing the spring against fixing block 265b. On release of the touch bar 208 the safety springs return the cranks and touch bar to their thrown positions.

The portion of the action slider between the cranks and the safety springs, such as including spring blocks 265a, 265b, may be considered to be a receiving portion receiving the user force, and the portion of the action slider between the safety springs and the coupling 240, such as the fixing blocks 266a, 266b, may be considered to be a transmitting portion transmitting movement from the motor rod.

The action of the safety springs is to prevent damage to the touch bar assembly when movement of the action slider is blocked. We will describe this blocking further later in the description. When blocked and the touch bar has significant force applied to it, such as up to 1000N or more, the safety springs compress absorbing this force. Such forces may occur when the touch bar is under attack or being pressed by multiple people such as a crowd.

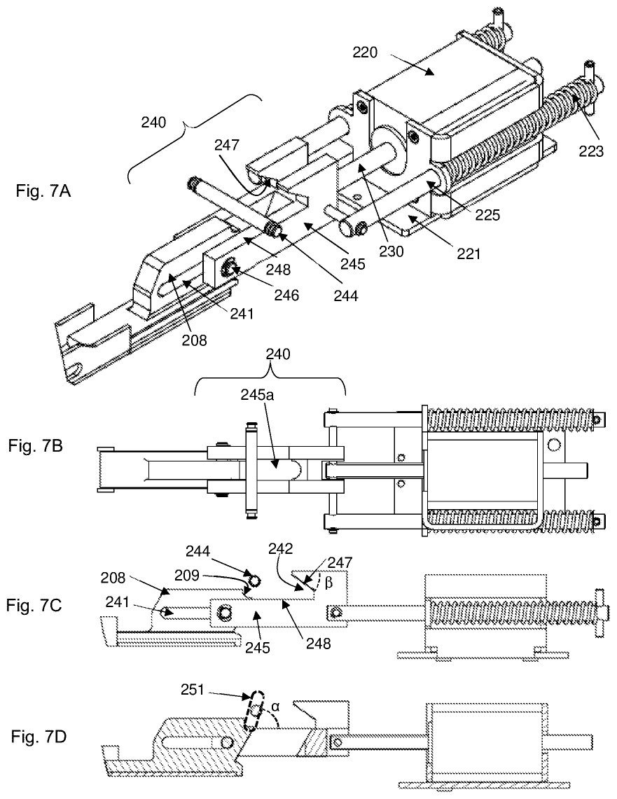

Returning to FIGS. 5A-5C we now describe the components shown towards the right hand of the figure which include a motor 220, motor rod 230 and coupling 240 comprising a gate. These components perform functions of blocking movement of the action slider 208, releasing the action slider for retraction, and providing motorised movement of the action slider such as to retract the bolt. FIGS. 7A-7D show in more detail these components. FIG. 7A is a perspective view and FIGS. 7B-7D respectively are a top plan view, a side view and a cross-sectional view taken along the longitudinal centreline of the components shown in FIG. 7B.

Motor 220 is located at one end of the touch bar assembly and is shown at the right hand side of FIGS. 5A-5C. Motor 220 may be a stepper motor that drives motor rod 230. Motor rod passes through the motor. The motor rod may be a threaded rod such as may be driven by a stepper motor. The motor may be a stepper motor that spins a core having a thread matching that of the rod. The core may be like a nut and the motor acts by spinning the core which moves the rod laterally in the appropriate direction. Other different types of motor and stepper motor may alternatively be used. For example, the motor may be a conventional motor that rotates a threaded shaft. A component with a threaded hole and the shaft extending through the hole will be driven laterally as the shaft turns. The component would be coupled similarly to the rod.

The motor 220 is fixed to base 260 of touch bar assembly 200 by bracket or mounting 221. Motor rod 230 couples to action slider 208 by coupling 240 which comprises a gate. Various configurations of coupling and gate may be possible. We describe herein preferred embodiments of the coupling and gate. The opposite end of action slider 208 to the hooked portion 258 is seen in FIGS. 7A-7D comprising a slot which we shall denote as slider slot 241. The slider slot 241 extends in a direction parallel to the longitudinal direction of the action slider 208. Between action slider 208 and motor rod 230 is carriage 245. The carriage 245 is coupled to the end of motor rod 230 to be driven backwards and forwards by motor rod 230. Carriage 245 includes a channel 245a which receives the end of the action slider 208 and in which the action slider can move laterally. The end of the channel 245a may be shaped to match the shape of the end of the action bar so that the two can move close together. The carriage 245 is coupled to the action slider 208 by carriage rod 246 which is located in slider slot 241. The carriage rod 246 is fixedly coupled to the carriage but is arranged to slide in the slider slot such that the carriage is coupled to the action slider but movement of the action slider relative to the carriage is permitted in a lost motion manner. The other end of the carriage is coupled to the motor rod 230. Motor springs 223 provide a bias to the carriage 245 to pull the carriage towards the motor 220. The motor springs 223 are coiled compression springs, although other types of spring may alternatively be used. Two motor springs 223 are provided, one each side of the motor 220. The bracket or mounting 221, or alternatively the motor housing itself, may comprise holed tabs or rings through which bias rods 225 pass. Each motor spring 223 may be provided with a bias rod 225 passing through it and coupled to a first end of the motor spring. The second end of the motor springs 223 abut against the holed tabs or rings through which the bias rods pass. The bias rods are also coupled to carriage 245 at an opposing end to the action slider 208. The coupling of the bias rods 225 to the carriage may be by a fastening such as the same fastening that the motor rod 230 is coupled to the carriage 245. This motor rod-to-carriage coupling may be a pin or bar that passes through the ends of the motor rod, bias rods and one end of the carriage. The motor rod-to-carriage coupling may allow the carriage to pivot with respect to the motor rod and bias rods. This allows for the small amount of rocking movement as the action slider 208 moves. The combination of motor springs 223 and bias rods 225 act to pull the carriage towards the motor.

As can be seen in FIGS. 7A-7D the carriage includes a ramp comprising a sloping surface 247 or a pair of sloping surfaces, which as we will describe below are driving surface(s). As mentioned above, the carriage may comprise a channel in which the action slider 208 moves. Either side of this channel are guiding surfaces 248 which towards one end face the ramp driving surfaces such that the ramp driving surfaces and guiding surfaces together form a mouth 242 into which a stopping bar 244 may be received. Stopping bar 244 is shown in FIGS. 5A-5C and FIGS. 7A-7D. However, the mounting of the stopping bar is not shown in FIGS. 7A-7C. Coupled to base 260 is a mount 250 comprising walls extending from the base and either side of the carriage 245. The mount comprises slots 251 in the walls into which the stopping bar 244 extends. The slots 251 are angled extending away from the base 260 and slightly towards the motor. FIG. 7D shows the positioning of slot 251. As can be seen in FIG. 7D the slot is at angle α, which is preferably between 60° and 80° to the longitudinal direction of the touch bar assembly. More preferably, the angle is between 70° and 80°, such as at 75°. The stopping bar 244 is biased to moved up the slot away from the carriage 245 and action slider 208. The bias is provided by springs 252 which can be seen in FIGS. 5A and 5C. Springs 252 may be coiled springs that are tension springs. The springs may couple to the ends of stopping bar and to the walls of mount 250. The walls may have an extension tab to which the spring is coupled. The springs may pull in a direction similar, although not necessarily the same as the direction of the slot. However, a component of the spring pull direction should be sufficient to pull the stopping bar 244 along slot 251.

The mouth 242 on carriage formed by guiding surfaces 248 and sloping ramp surfaces 247 is arranged to collect stopping bar and move it downwards against the action of the springs 252. We will describe below how this action relates to various different states of the touch bar assembly. However, here will describe how the movement of the carriage moves the stopping bar. As discussed above, carriage 245 is driven by motor rod 230. In FIGS. 7C and 7D the stopping bar 244 is shown as above the action slider 208 and carriage such that the action slider can move towards the motor passing under the stopping bar (in the orientation shown in FIGS. 7C and 7D). The carriage 245 may driven away from the motor by movement of the motor rod 230. This brings mouth 242 closer to stopping bar. As the carriage approaches the stopping bar 244 the sloping ramp surfaces 247 push against the stopping bar. The direction of movement of the stopping bar is limited in that it can only move along slot 251. The sloping ramp surfaces 247 are sloped such that as the carriage is pushed further by the motor rod the sloping ramp surfaces pull the stopping bar downwards along the slot 251 towards the action slider 208. This movement is against the action of springs 252. As can be seen in FIGS. 7C and 7D the end of action slider 208 includes at its top a curved recess 209. As the stopping bar is pushed further downward by mouth 242 of carriage, the stopping bar is pushed into the recess 209 at the end of the action slider. In this position the stopping bar performs a blocking action against movement of the action slider, because it effectively blocks the path of movement of the action slider. We will describe the blocking action in more detail later in the description.

The sloping ramp surfaces 247 slope downwards at angle [symbol] below the horizontal to form the mouth 242. The angle is preferably between 25° and 45, and more preferably between 30° and 40° such as around 35°. The angle of the sloping surface is set such that it is easy to drive the stopping bar downwards as the carriage is moved towards the action slider and away from the motor. The angle of the slot 251 in which the stopping bar 244 moves is angle α which, as we have discussed above, may be 75°. It can be seen that the angle of the slot crosses the angle of the sloping surface. The angle of the slot 251 is set such that a high force is required in the longitudinal direction of the action slider to push the stopping bar back towards the motor. This is because viewed from the longitudinal direction of the action slider the angle of the slot is steep so only a small part of the applied force actually moves the stopping bar. Conversely, in the upwards direction such as away from the base 260 a smaller force may be required to push the stopping bar upwards. This is because the angle of the slot means that most of the upwards force is used to move the stopping bar. As described above, a preferred angle for α is 75°. If it is required that to make it easier to push the stopping bar along the slot using a horizontal force then the angle of the slot 251 should be adjusted at manufacture to closer to 45°. However, if it is required to make it harder to push the stopping bar along the slot using a horizontal force then the angle of the slot should be adjusted steeper and closer to 90°.

We have described various components of FIG. 7. The coupling is identified by reference number 240 and may be considered to comprises the carriage 245, stopping bar 245 and slot 251, along with fasteners or fixings to couple the carriage to the action slider 208 and motor rod. The coupling comprises the gate. The gate may be considered to be the stopping bar 244 which moves in slot 251. Other shapes and variations of components for the coupling an gate may be provided.

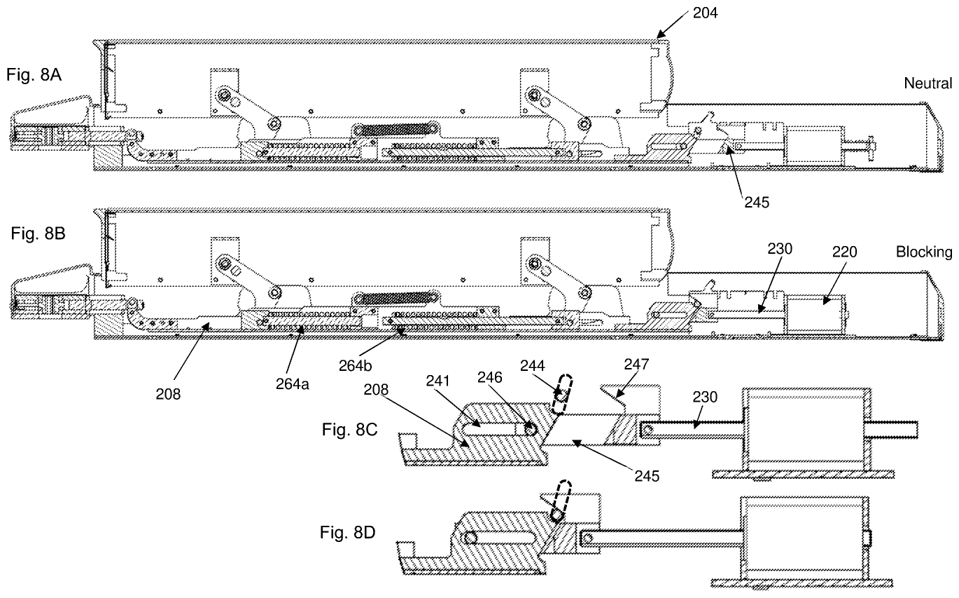

With reference to FIGS. 8 to 11 we now describe operation of the touch bar assembly. FIGS. 8A and 8B show sectional views of the touch bar assembly taken along the centreline in the same way as FIG. 5B. FIGS. 8C and 8D are similar to FIG. 7D showing sectional views of the components, including the gate and coupling, that perform functions of blocking movement of the action slider 208, releasing the action slider for retraction, and providing motorised movement of the action slider such as to retract the bolt. FIGS. 8A and 8C show the touch bar assembly and components in a neutral position or mid-position similar to FIG. 3C, with the touch bar and action slider thrown but ready for retraction. FIGS. 8B and 8D shown the touch bar assembly and components in a blocking position similar to FIG. 3B. In relation to FIG. 3 we described a gate that moves to block movement of the actions slider.

FIGS. 8A and 8B show the touch bar 204 in the thrown position and the action slider also in the thrown position. To move to the blocking configuration, motor 220 drives motor rod 230 towards the action slider 208. The carriage 245 is coupled to the motor rod and also driven forwards towards the action slider 208. In FIGS. 8B and 8D it can be seen that the carriage 245 and motor rod are moved to the left in comparison to FIGS. 8A and 8C. Carriage 245 is coupled to action slider 208 by carriage rod 246 which moves in slider slot 241 in action slider. Between the neutral position shown in FIGS. 8A and 8C and the blocking position shown in FIGS. 8B and 8D the slider slot guides the movement of the carriage rod 246 and carriage 245. As described earlier, as the carriage 245 moves towards the action slider the ramp surfaces 247 of the mouth 242 push against the stopping bar 244. The movement of the stopping bar is constrained in slot 251 such that as the mouth pushes further against the stopping bar the stopping bar is pulled downwards towards the action bar. As can be seen in FIG. 8D the stopping bar is now located in the recess 209 at the end of the action slider 208. With the stopping bar in this position the action slider cannot be moved by pressing the touch bar because the stopping bar in the recess is in the path of movement of the action slider 208. The mouth 242 of the carriage holds the stopping bar in position. Here the stopping bar is in a blocking configuration. Hence, the gate may be considered to be closed. The motor 220 has a brake which holds the motor rod at the blocking configuration position shown. Since the motor is a stepper motor the brake may be part of the motor. Alternatively, the brake may be added separately, such as if a conventional motor is used. As mentioned above, the motor rod may be a threaded rod which is driven by the motor. The brake may engage the threads of the motor rod to stop movement of the motor rod, or the brake may act on moving parts in the motor to stop movement. The brake provides a force that prevents driving back of the stopping bar 244 when a force is applied to the touch bar. However, the braking force that the brake is able to apply is limited and it is desirable that the touch bar assembly can withstand a greater level of force than this limited amount before retraction of the bolts occurs. The stopping bar 244 in slot 251 is provided at an angle to increase the force that may be applied to the touch bar without the action slider and bolts retracting. As mentioned above, pushing the stopping bar out of the way is difficult when the force is applied by a user on the touch bar to push the action slider. As the force on the touch bar is increased the stopping bar does not move and the safety springs 264a, 264b are compressed as discussed in relation to FIGS. 6A-6C. With the safety springs fully compressed or close to full compression, the touch bar is also fully depressed and can be pushed no further. The touch bar will bottom out with parts of it hitting the base. Since the touch bar can be pressed no further, egress is limited until the motor is powered back or power is removed from the motor.

Release of the blocking action is the reverse of applying the blocking action. If the release is with the motor powered, the motor moves motor rod against the bias of motor springs 223. If the release is due to a loss of power, then the motor springs themselves pull the motor rod to release the blocking configuration. The unpowered action may not move the motor rod to the same position as the powered action but it will be sufficient to release the blocking action. User force can then move the motor rod a sufficient amount to permit retraction of the bolts.

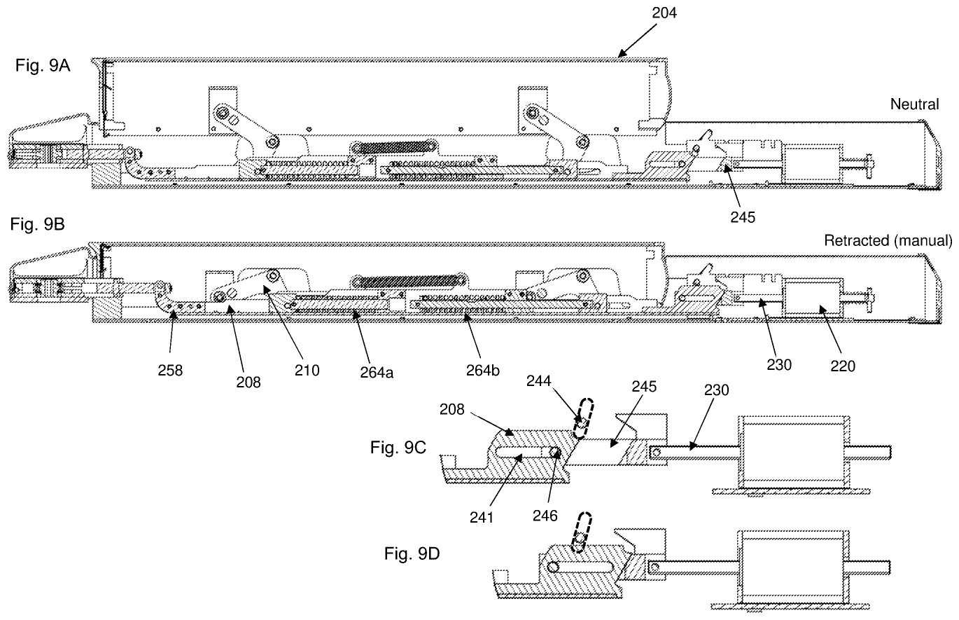

We now describe manual retraction of the action slider and bolts with reference to FIGS. 9A-9D. FIGS. 9A and 9B show sectional views of the touch bar assembly taken along the centreline in the same way as FIG. 5B. FIGS. 9C and 9D are similar to FIG. 7D showing sectional views of the components that perform functions of blocking movement of the action slider 208, releasing the action slider for retraction, and providing motorised movement of the action slider such as to retract the bolt. FIGS. 9A and 9C show the touch bar assembly and components in the neutral position or mid-position similar to FIGS. 3C, 8A and 8C, with the touch bar and action slider thrown but ready for retraction. FIGS. 9B and 9D shown the touch bar and action slider in the retracted position similar to FIG. 3D.

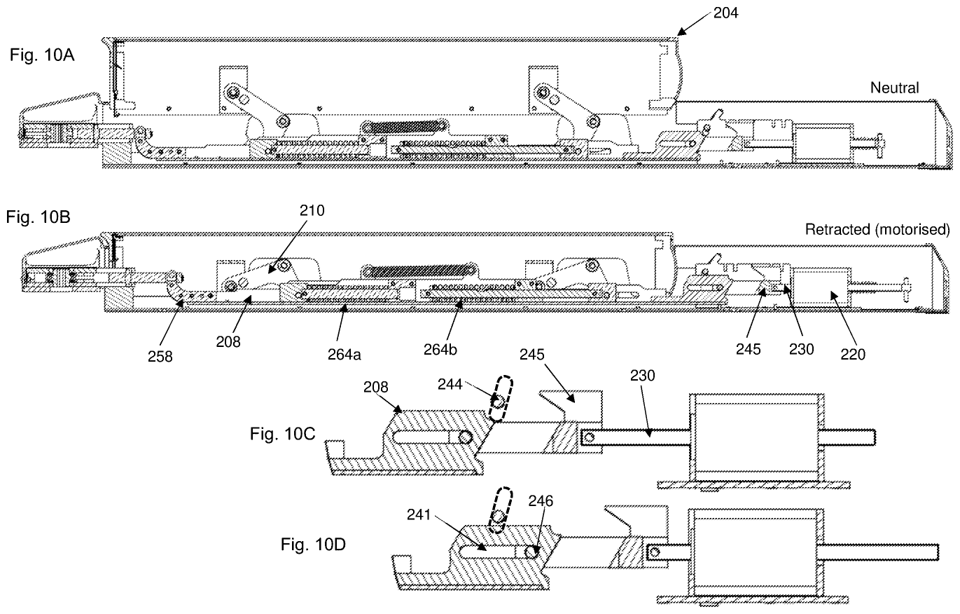

In FIG. 9A the motor rod 230 is shown in the neutral position or mid-position. In this position the stopping bar 244 is clear of the path of the action slider 208 and the action slider is able to move to retract the bolts of the bolting mechanism. The action slider may be moved manually by depressing the touch bar 204 or electrically by driving the motor 220. FIGS. 9A-9D relate to manual retraction of the bolts which we now describe. Motorised retraction is described in FIGS. 10A-10D. FIG. 9B shows touch bar 204 has been retracted by a user force pushing against the touch bar to depress the touch bar. Depressing of the touch bar 204 causes cranks 210 to rotate. This is shown in FIGS. 9A and 9B as an anticlockwise rotation. The cranks 210 push the action slider 208 towards the motor (towards the right hand direction in FIG. 9B). In FIG. 9B the retraction of the action slider 208 can be seen by the hooked portion 258 of the action slider 208 near the bolting mechanism is retracted. The hooked portion 258 has acted to retract the component of the bolting mechanism that releases the bolts. As the movement of the action slider is not blocked the safety springs 264a, 264b move with the action slider without compressing, as shown in FIG. 9B. Between the neutral and retracted positions of the action slider shown in FIGS. 9A-9D the motor rod 230 has not moved because the retraction has occurred manually. Hence, the carriage 245 is also in the same position in FIGS. 9A-9D. The end of the action slider 208 closest to the motor that includes the slider slot 241 and recess 209 has moved to the retracted position, as shown in FIGS. 9B and 9D. Carriage rod 246 also remains in the same position between FIGS. 9C and 9D but the slider slot 241 of action slider 208 has moved along relative to the carriage rod 246. This may be considered to be lost motion between the carriage 245 and action slider 208. The manual retraction of the action slider is permitted by this lost motion such that without moving or powering the motor the action slider is able to move manually.

Turning now to FIGS. 10A-10D we describe motorised retraction of the action slider and bolts of the bolting mechanism. FIGS. 10A and 10B show sectional views of the touch bar assembly taken along the centreline in the same way as FIG. 5B. FIGS. 10C and 10D are similar to FIG. 7D showing sectional views of the components that perform functions of blocking movement of the action slider 208, releasing the action slider for retraction and providing motorised movement of the action slider such as to retract the bolt. FIGS. 10A and 10C show the touch bar assembly and components in the neutral position or mid-position similar to FIGS. 3C, 8A, 8C, 9A and 9C, with the touch bar and action slider thrown but ready for retraction. FIGS. 10B and 10D shown the touch bar and action slider in the retracted position similar to FIG. 3D. Different to FIGS. 9A-9D the retraction shown in FIGS. 10B and 10D has occurred by motorised movement of the action slider.

As shown in FIG. 10A the motor rod is in the neutral or mid-position. In this position the stopping bar 244 is clear of the path of the action slider and the action slider is able to move to retract the bolts of the bolting mechanism. As shown in FIG. 10B the motor 220 has retracted motor rod 230 pulling the carriage 245 towards the motor. For example, it can be seen in FIG. 10B in comparison to FIG. 10A that a shorter length of motor rod extends out of the left side of the motor and a longer length out of the right side of the motor. Carriage 245 can also be seen to be closer to motor 220. In FIGS. 10A and 10C the motor rod 230 is in the neutral position and carriage rod 246 is at the end of slider slot 241 of action slider 208. As the motor retracts the motor rod 230 the carriage rod 246 pulls on the end of slider slot 241 pulling the action slider 208 towards the motor. In FIGS. 10B and 10D the carriage has been moved towards the motor and the action slider is also moved towards the motor. As for FIGS. 9A and 9B, the safety springs 264a, 264b, move with the action slider, as do the cranks. The safety springs are not compressed. The cranks rotate down as if pushed by the touch bar such that the touch bar is moved as if it has been depressed. That is, the touch bar is moved to the retracted position by the motor driving of retraction. As can be seen in FIG. 10B, the hooked portion 258 of action slider has moved to pull on the component connecting to the bolting mechanism so as to retract the bolts.

By enabling the touch bar assembly to have motorised movement of the action slider and retraction of the bolts, the touch bar assembly can be used with access control systems. Such access control systems may operate to retract and throw bolts electrically. For example, a user wishing to exit or enter through a locked door can present an access card against a reader or enter a PIN number into a PIN pad. If the card is authorised or the PIN number is correct the access control system authorizes entry or exit and sends an electrical signal to the touch bar assembly to retract the bolt using the motor.

As mentioned, delayed egress is enabled by having the touch bar assembly configured to release and optionally retract the bolts electrically. We will now describe the function and operation of delayed egress. Delayed egress allows the touch bar to release bolts after a short delay following attempted pushing of the touch bar by a user. The delay may be 5, 10, 20 or 30 seconds, for example. The delay is usually used as a security feature. For example, as discussed in the background section usually a person wishing to exit in an emergency wishes to escape from the building because of a fire in the building. However, a person stealing goods may use an emergency exit to escape a building because it may provide a rapid way to exit and/or by exiting through the emergency exit the person may avoid security at the main entrance or exit doors. The delayed egress provides a short delay to the release of the bolts and emergency exit doors which may provide sufficient time for a person stealing goods to be noticed and stopped. The delayed egress is usually of a short duration in case there is an emergency such as a fire in the building. Furthermore, if a fire is identified the delayed egress function may be removed and/or the motorised release may be used to release the bolts secured by the touch bar.

A touch bar providing delayed egress will include a sensor to identify when the touch bar is pushed. For example, by referring to FIG. 6 a sensor may be located at a position along the length of the touch bar to monitor any depressing movement. The sensor may be a microswitch or reed switch (Hall effect switch). Alternatively, a sensor or switch may be located at a position along the length of the action slider to monitor movement there. In delayed egress mode the motor rod would be in the blocking position to prevent movement of the action slider and retraction of the bolts. The touch bar is configured to allow a small amount of movement when pressed. This is achieved by a small gap, such as around 2 mm, between the edge of the curved recess 209 (see FIG. 7C) in the action slider and the position of the stopping bar 244. The gap allows enough movement for the action slider to be pushed slightly to activate a monitoring switch. The gap also allows the stopping bar to lift or fall unhindered by the recess when needed. A sensor will detect the small amount of movement, such as the 2 mm, and start a timer for the required delay. Once the delay has expired a signal is supplied to the motor 220 to move the motor rod 230 from the blocking position to the retracted position. A controller may be connected between the sensor and motor to receive a signal from the sensor, commence a timer and operate the motor after the time has expired. Delayed egress comprises moving the motor rod and action slider from a blocking position such as in FIGS. 8B and 8D, to the neutral position such as in FIGS. 8A, 8C, 10A and 10C, and further to the retracted position such as shown in FIGS. 10B and 10D, by action of the motor. Alternatively, delayed egress may comprise moving the motor rod and action slider from a blocking position such as in FIGS. 8B and 8D, to the neutral position such as in FIGS. 8A, 8C, 9A and 9C, where upon manual pressure on the touch bar moves the action slider to the released position shown in FIGS. 9B and 9D.

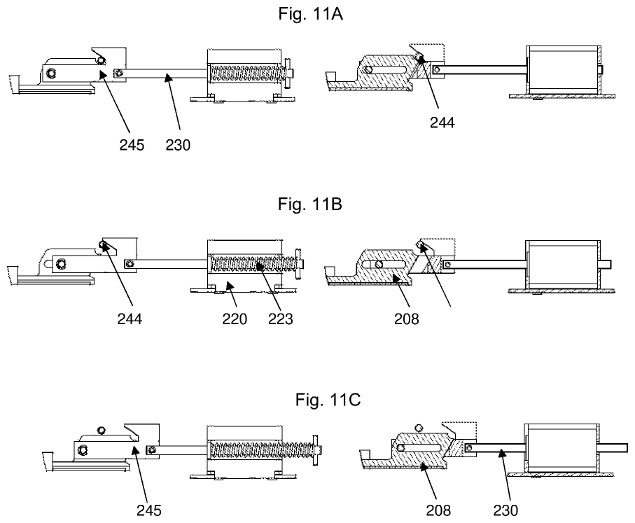

We have described how delayed egress operates normally when the touch bar assembly is powered. FIGS. 11A-11C show steps of egress when there is a power failure or when power is turned off, for example, during a fire. Each of FIGS. 11A-11C includes two images. The left hand image in each of FIGS. 11A-11C is similar to FIG. 5C which is a side view of the motor and other components, and is included to show the position of motor springs 223. The right hand image in each of FIGS. 11A-11C is similar to FIG. 5D which is a cross-section taken through the centreline of the motor, and is included to show the position of the carriage rod 246 in slider slot 241.

In FIG. 11A the carriage 245 is pushed fully forward by the motor rod such that the components are in the blocking configuration, including having the stopping bar in the recess at the end of action slider to block movement of the action slider. In FIG. 11B power has been removed such that the motor brake is disabled. The carriage 245 partially retracts towards the motor rod 230 under tension provided by motor springs 223. The partial retraction of the carriage 245 releases the stopping bar 244 and allows it to move out of the path of the action slider 208 under the bias of springs 252. FIG. 11C shows that the action slider 208 and motor rod 230 have been moved to retracted positions. This is by manual action of the touch bar 204 by pushing by a user. The carriage 245 is also moved back. In this position the action slider 208 is retracted to retract the bolts and release the door for egress.

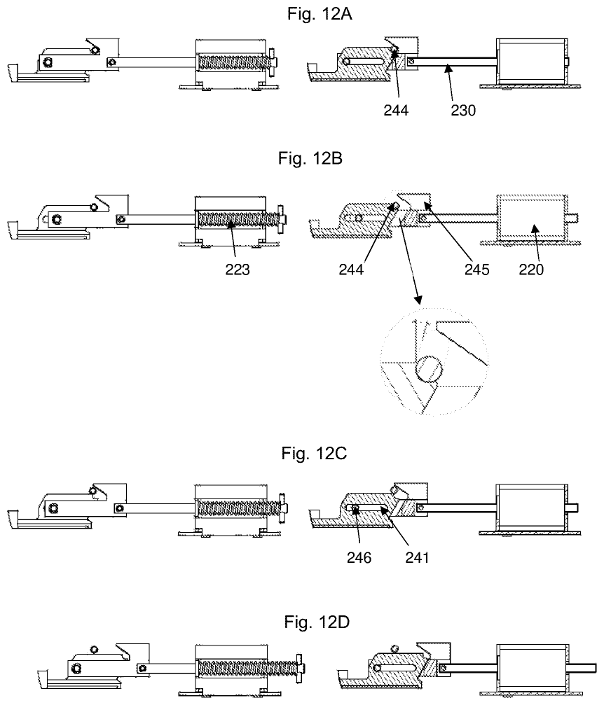

FIGS. 12A-12D shows steps of egress in a special case when pressure or a load is continuously applied to the touch bar 104. Each of FIGS. 12A-12D includes two images. The left hand images in each of FIGS. 12A-12D are similar to the left hand figures in FIGS. 11A-11C showing side views of the motor and other components, and are included to show the position of motor springs 223. The right hand images in each of FIGS. 12A-12D are similar to the right hand figures in FIGS. 11A-11C which are cross-sections taken through the centreline of the motor, and are included to show the position of the carriage rod 246 in slider slot 241.

In FIG. 12A the motor rod 230 is in the blocking position with mouth of the carriage holding the stopping bar in the blocking position blocking movement of the action slider. Force is applied to the touch bar pushing the action slider up against the stopping bar 244 such that the surfaces of the recess at the end of the action slider push against the stopping bar. In FIG. 12B power is no longer supplied to the motor which, similar to FIG. 11B, results in the motor brake being disabled and the carriage is partially retracted under the tension of motor springs 223. Differently to FIG. 11B, with the load continuing to be applied to the touch bar, the stopping bar 244 is held in position in the recess at the end of the action slider preventing movement of the action slider. In FIG. 12C the load is increased and the stopping bar is forced upwards in the slot 251 to clear the slider and allow retraction. In FIG. 12D the continued force or load provided by the user pushes the action slider further retracting the bolts. In FIG. 12D it can be seen that the manual retraction has pushed back the motor springs 223 and motor rod 230 such that the motor rod is at the neutral position. The lost motion, resulting from carriage rod 246 moving in slider slot 241, between the action slider 208 and carriage 245 allows the action slider to be at the retracted position. As can be seen the loss or removal of power in FIG. 12B causes the motor springs to pull the motor rod, carriage and action slider back towards the neutral position but further manual pushing is required to fully push the motor rod to the neutral position.

FIGS. 13A and 13B are side and top plan views of the interface between the touch bar and the bolting mechanism. As mentioned above, the action slider 208 may have a hooked portion 258 at the end proximal to the bolting mechanism. The bolting mechanism may comprise a slide arm 520 which couples to cam 510. The hooked portion couples into a hole in the slide arm 520. The slide arm is coupled at the other end to an off-centre part of cam 510. Retraction of the action slider 208, as shown by arrow R1 in FIG. 13B, pulls on the slide arm 520 as shown by arrow R2 in FIG. 13A. The lateral movement of the slide arm is coupled to rotation of the cam as shown by the arrow R3. The rotation is used to rotate gears or rotors, for example, in the bolting mechanism that engage with bolts and retract the bolts to allow a door to be opened. Other mechanisms for coupling between the touch bar and bolts are possible.

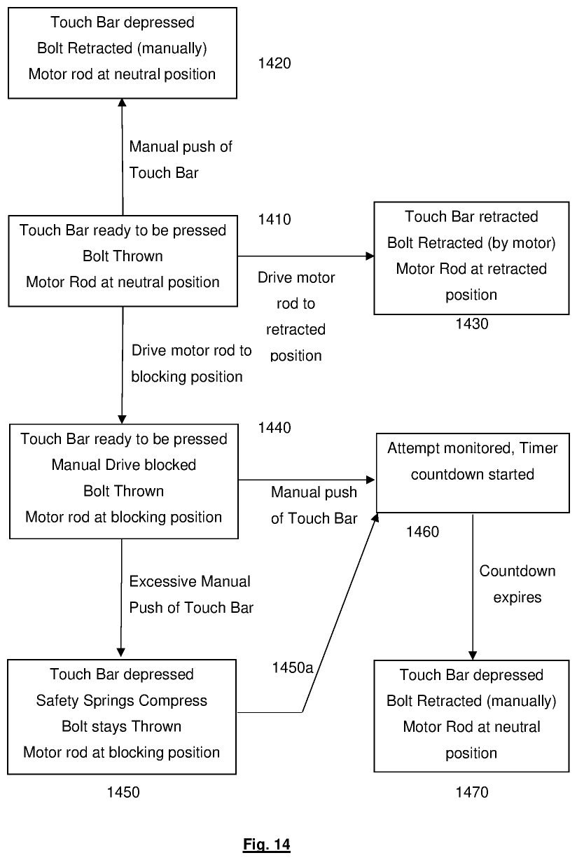

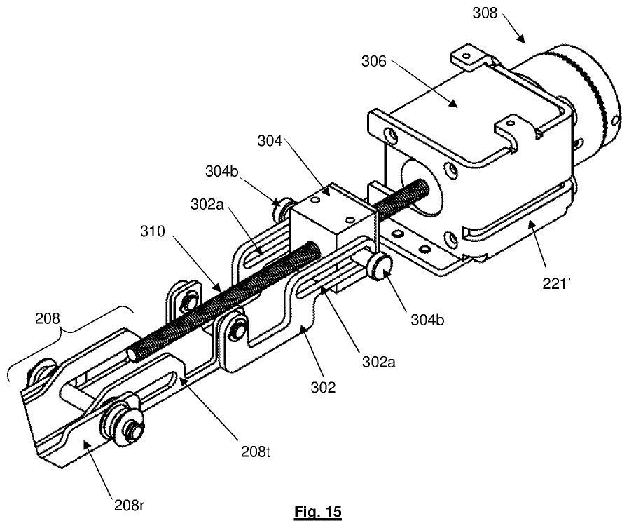

FIG. 14 is a flow diagram showing the different operation steps of the touch bar assembly described herein. Block 1410 represents the neutral position in which the bolts are thrown to secure the door. The motor rod is at the neutral position and the touch bar is free to be depressed to retract the bolts. At block 1420 the touch bar has been manually depressed and the bolts are retracted. The motor rod is not moved and remains in the neutral position. Alternatively, as shown as block 1430 instead of retracting the bolts by the touch bar they can be retracted by operation of the motor to move the motor rod to the retracted position. Returning to the neutral position of the motor rod at block 1410, the motor rod may be driven to a blocking position as shown at block 1440. If strong or excessive manual force pushing the touch bar occurs then the safety springs compress moving to block 1450. At block 1450 the bolts stay thrown and the motor rod remains at the blocking position and egress is prevented. Returning to the motor rod at the blocking position at 1440, if a manual attempt at pushing the touch bar occurs, this may be detected and start a timer for delayed egress at 1360. When the countdown expires, the motor rod is moved to the neutral position and further pushing of the touch bar retracts the bolts at 1470. As indicated by arrow 1450a, the strong or excessive manual force at 1450 may also be monitored as an attempt to release the touch bar, such that this also starts the timer countdown at 1460 for delayed egress. Movement back through the blocks is achieved by reversing the steps shown.

FIG. 15 is a perspective view of another embodiment of a motor and coupling arrangement for configuring the touch bar assembly for modes in which: i) pressing or actuation of the touch bar is blocked; ii) manual retraction of the bolts(s) is provided by pushing the touch bar; and iii) motorised retraction of the bolts such as in a delayed egress mode. The features shown in FIG. 15 are provided as an alternative embodiment to those shown at the right hand side of FIGS. 5 and 6 and also in FIG. 7. The embodiment of FIG. 15 may be considered to provide a simplified and improved arrangement compared to FIG. 7.

Turning to FIG. 15 in more detail, the end of the action slider 208 can be seen. As discussed previously, this may comprise a receiving portion which receives the user force when the touch bar 204 is depressed, and a transmitting portion which transmits the force to retract the bolt or bolts. The receiving portion and transmitting portion are respectively identified 208r and 208t in FIG. 15. The receiving portion and transmitting portion are linked by one or more safety springs (not shown in FIG. 15) which absorb user force on the touch bar in the event that movement of the action slider is blocked.

In FIG. 15 coupling 302, linear actuator 304 and motor 306 are shown. The coupling may be an extension of the action slider, that is, it could be integrally formed as part of the action slider, or as shown in FIG. 15 it is connected to the action slider. In FIG. 15 the coupling is shown as connected to the action slider by pins or bolts. The motor 306 is similar to the motor 220 of FIG. 5, for example. Motor 306 is configured to drive linear actuator 304 backwards and forwards. In the embodiment of FIG. 15 the motor is shown to drive a threaded motor rod 310. The motor 306 rotationally drives the threaded rod. Although in FIG. 15 all of the motor rod that can be seen is threaded, in alternative arrangements only a portion of the rod may be threaded. Linear actuator 304 may be a block or unit that is driven by the motor, and may comprises a threaded hole through which the threaded portion of the motor rod passes. On rotation of the motor rod by the motor, the linear actuator 304 moves toward the action slider or away from the action slider. The coupling may comprise a pair of plates as shown on FIG. 15 or a U-channel section or other arrangement. The coupling may comprise a pair of slots 302a which extend parallel to the motor rod and the direction of motion of action slider. The linear actuator may further comprise studs 304b, pins or rods which extend into the slots 302a. The studs 304b may each include a head of larger diameter than the slot such that the stud is retained in the slot.

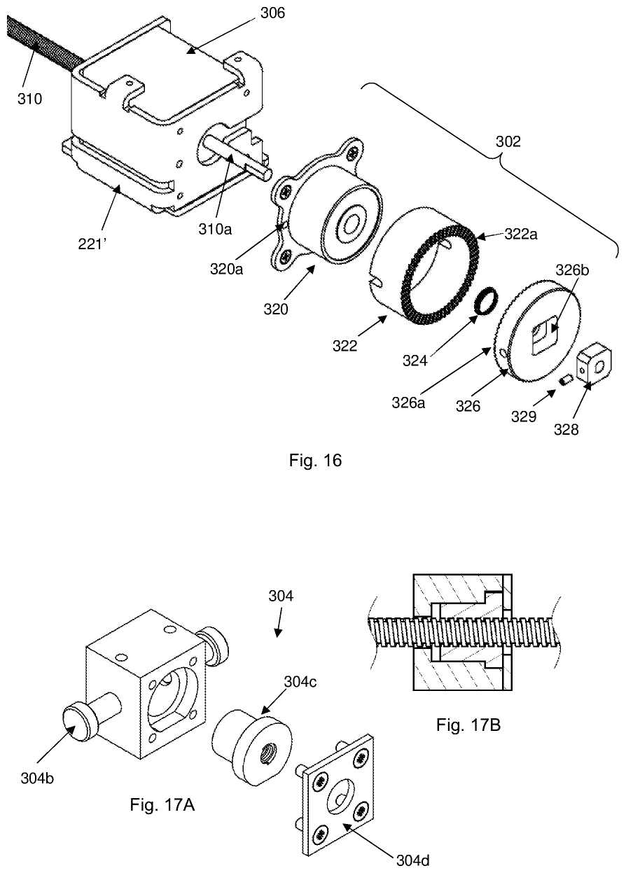

FIG. 15 also shows bracket or mounting 221′ which is similar to the bracket or mounting 221 of FIG. 7A. The bracket or mounting 221′ fixes the motor to the base housing or backplate of the touch bar assembly. At the rear of motor is shown brake 308 which is shown in more detail in FIG. 16. FIG. 17 shows more detail of the structure of the linear actuator 304.

FIG. 17A is an exploded view of linear actuator 304 and FIG. 17B is a cross-sectional view through the block or unit of the linear actuator in the axial direction. As described in preceding paragraphs the linear actuator includes a threaded portion to receive the thread of the motor rod or spindle. The threaded portion may be provided on a collar 304c or captive nut held in the block. The collar or captive nut may sit in a hole in the block and be prevented from rotating by a flat in the hole and a corresponding one on the nut or collar. The nut or collar may be held in position in the block by cover or plate 304d which fits over the hole in the block or unit of the linear actuator, and is held in place by fixings such as screws. Cross-sectional view in FIG. 17B shows that the holes in cover and block may be clearance holes that the threaded motor rod freely passes through, whereas the collar or nut has a thread which constrains the linear actuator on the thread of the motor rod.

FIG. 16 is an exploded perspective view of the motor 306 and brake 308. As discussed in the preceding embodiment the motor may be a stepper motor that comprises a braking action. However, the strength of the braking action is often limited and can be overcome by a relatively modest manual force. Hence, embodiments described herein aim to increase the force required to overcome the braking action. In the embodiment of FIGS. 15 and 16 the brake 308 is provided to address this problem. Brake 308 comprises an electromagnet 320 and a pair of teethed units 322 and 326. First teethed unit 322 is affixed to the electromagnet and second teethed unit is coupled to the motor rod. When the electromagnet is energised the two teethed units are pulled together such that the teeth engage and the rotation of the motor rod is prevented. Although many other arrangements are possible, we describe in more detail the arrangement of components shown in FIG. 16.

Motor rod 310, at least part of which is threaded, which extends from the front or first side of the motor also extends from the rear or second side of the motor. The motor rod 310a extending from the rear of the motor is preferably not threaded but may include a flat portion. Electromagnet 320 is preferably of annular shape such that there is a hole or space for the motor rod 310a to extend through. The electromagnet may be fixed to the bracket or mounting 221′ that holds the motor rod to the housing of the touch bar assembly. Around the electromagnet is fitted a sleeve 322 which is also annular. The sleeve has a circular wall with sufficient thickness that teeth 322a may be formed in the wall. The sleeve is mounted to the electromagnet prior to assembly of the electromagnet to the motor. Sleeve is attached to motor by a fixing such as a screw through hole 320a in a housing part of the electromagnet. Also shown in FIG. 16 is a rotor 326 which is configured to fit onto the end of motor rod 310a. The rotor 326 is preferably circular and includes teeth 326a formed on a surface of the rotor towards its edge at a corresponding radius from the axis of the motor rod 310a so as to be able to engage with the teeth 322a of the sleeve 322. A retaining component 328 is used to keep the rotor coupled to the rod. The retaining component may have a square outside shape to fit in a square recess 326b in the rotor. The retaining component has a central hole into which the motor rod 310a is received. The hole has a flat similar to the flat on the motor rod such that there is no rotational slippage between the motor rod 310a and retaining component 328. A fixing 329 such as grub screw or glued rod fixes the retaining component to the motor rod such as close to the end of the rod. Rotor 326 is held on the motor rod by retaining component but is free to move along the motor rod 310. The square recess 326b in the rotor is closely fitting to the retaining component such that rotation of the retaining component by the motor rod 310a causes rotation of the rotor without slipping. However, the rotor may also slide along the motor rod a small amount such as when attracted by the electromagnet. The thickness of the recess 326b in the rotor and the thickness of the retaining component are such that with the limited movement of the rotor along the motor rod, the retaining component is not fully released from the recess such that rotation of the motor rod remains keyed to the rotor.

Rotor may have access hole 326a to allow tightening of grub screw 329 into retaining component to hold retaining component to the motor trod. Once tightened grub screw 329 should not extend beyond the outer surfaces of the retaining component.

Also shown in FIG. 16 is spring 324 which sits between rotor 326 and electromagnet 320. Spring 324 biases the rotor away from the electromagnet. The spring provides a light bias that is overcome when the electromagnet is activated. The spring 324 provides sufficient bias to push the rotor away from the electromagnet such that the teeth of the rotor do not rattle and catch against the teeth of the sleeve when the electromagnet is deactivated. The teeth on both parts are cut with side angles of around 45° to the rotation axis. This provides a compromise between sufficient braking advantage and allowing the teeth of the two parts to separate when the electromagnet is deactivated and the touch bar is pressed. The teeth are shallow at around 0.5-3.0 mm deep or preferably 0.5-1.0 mm deep. This allows many teeth to be provided which provides quick engagement and with many faces in contact provides good mechanical braking force by friction. The two teethed components may have around 60 teeth each.

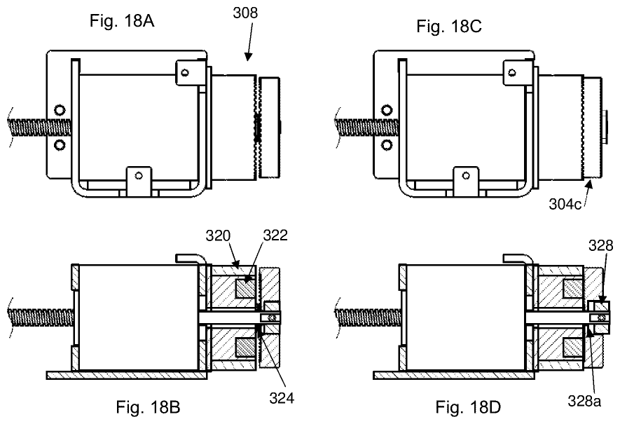

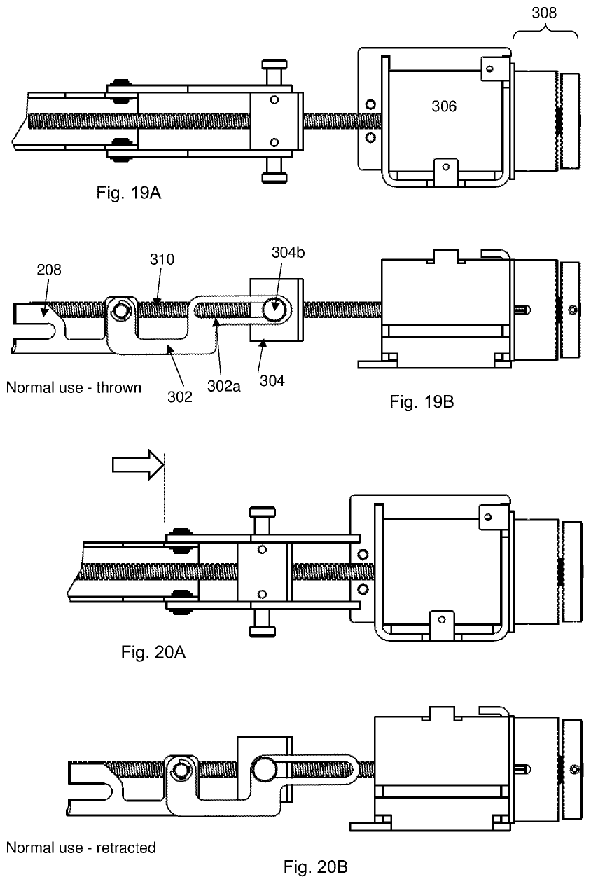

FIGS. 18A-18D provide further details of the brake 308 coupled to motor 306. FIGS. 18A and 18B are respectively top plan and side sectional views of the motor and brake with brake released. FIGS. 18C and 18D are respectively top plan and side sectional views of the motor and brake with brake activated to stop rotation of the motor rod. As shown in FIGS. 18A and 18B the rotor is spaced from the sleeve such that the teeth of the rotor and sleeve are not engaged. In FIG. 18B the spring 324 can be seen pushing the rotor away from the electromagnet 320. In FIGS. 18A and 18B the electromagnet is deactivated/not powered. In FIGS. 18C and 18D the electromagnet is powered. The rotor is at least partly made of ferromagnetic material such that it feels a force in the presence of a magnetic field. As shown in FIGS. 18C and 18D the rotor 326 has been pulled towards the electromagnet and spring 324 has been compressed. A space or void has opened in the recess 326b as the rotor 326 has been pulled away from the retaining component 328 towards the electromagnet. The teeth of the rotor are engaged with the teeth of the sleeve.

Although we have described the teethed components as rotor and sleeve, such teethed components may be provided in other ways. The electromagnet may also be provided with a shape that is not annular. For example, the sleeve may be more of a rectangular block comprising a pair of electromagnets arranged along a diameter. The rotor may be a shape other than circular. Furthermore, we describe that the electromagnet is powered to turn on the brake. In an alternative arrangement, the brake may have the electromagnet powered normally and power is removed when the brake is applied. This would require a different arrangement of rotor or rotors such that on removal of the power, a spring moves a stationary rotor towards the rotating rotor. Such an arrangement is less preferred because it would continuously draw power.

We now describe operation of the motor and coupling with reference to FIGS. 19-24. As described above the touch bar assembly has modes of operation in which: i) pressing or actuation of the touch bar is blocked; ii) manual retraction of the bolts(s) is provided by pushing the touch bar; and iii) includes motorised retraction of the bolts such as in a delayed egress mode.

We first refer to FIGS. 19 and 20 which show how manual operation of the touch bar moves the action slider 208 and coupling 302. FIGS. 19A and 20A are respectively top plan views and FIGS. 19B and 20B are side views of the motor with brake. In FIGS. 19A and 19B the action slider 208 is in the thrown position which corresponds to the configuration in FIG. 9A. In this position the touch bar 204 is thrown or extended and the bolt(s) are also thrown. The linear actuator is in the neutral position. As shown in FIG. 19B the linear actuator 304 is positioned such that studs 304b of the linear actuator are at one end of slot or guide 302a in coupling 302. In FIG. 19B the stud is shown at the right hand end of the slot or guide. This may be considered to be a second end of the slot or guide.

Moving to FIGS. 20A and 20B the touch bar 204 has been pushed rotating cranks 210 to drive the action slider 208 to the right (as shown in the figures). In this position the action slider has moved to retract the bolts to release the door. The movement of the action slider is also towards the motor, pushing the coupling 302 (which as noted previously may be part of the actional slider) such that the guide or slots move along the studs 304b of the linear actuator. As shown in FIG. 20B the studs are now at the opposite end of the guide or slots 302a, namely the first end. The linear actuator and motor rod are not moved between FIGS. 19 and 20, and the brake 308 is not activated. The lack of movement results from lost motion between the coupling 302 and the linear actuator 304.

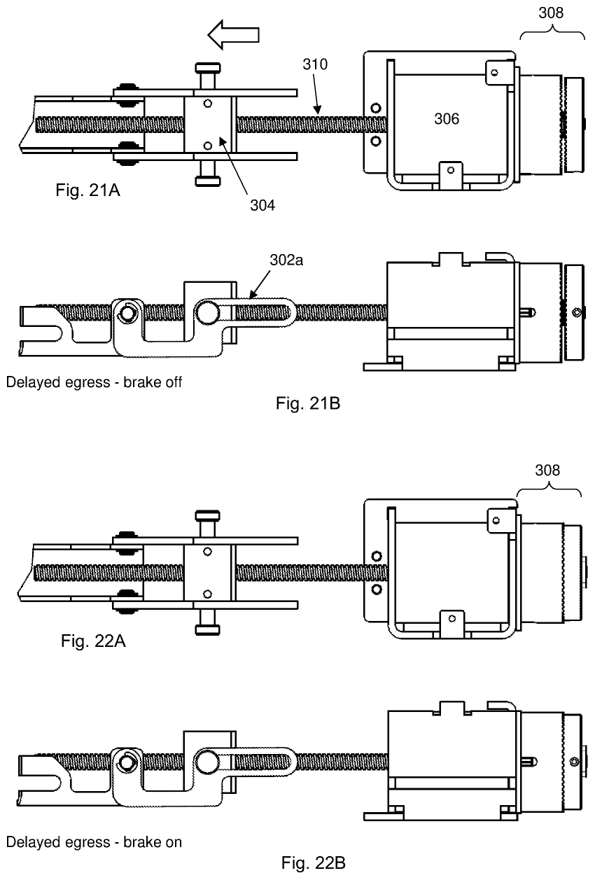

FIGS. 21 and 22 show application of the brake 308 to stop the motor, such as for implementing delayed egress. The position of the linear actuator 304 in FIGS. 21A and 21B is different to that in FIGS. 19 and 20. The linear actuator 304 has been driven away from the motor and towards the action slider by the motor 306. The motor has rotated the threaded motor rod 310 which has driven the linear actuator away from the motor as indicated by the arrow in FIG. 21A. The linear actuator is positioned with studs at the first end or left hand end of the slots or guides 302a in the coupling. In FIGS. 22A and 22B the brake 308 is applied to prevent rotation of the motor rod of the motor. Hence, on pushing of the touch bar 204, the transmitting portion of the action slider will be blocked from moving. This is because the transmitting portion will want to move towards the motor but this is blocked by the studs being at the first end of the guides. Furthermore, pushing of the linear actuator will not move it because to move requires the motor rod to be able to rotate but the brake 308 is preventing this. Accordingly, in this arrangement pushing of the touch bar 204 will result in the cranks rotating as shown in FIG. 6B and the safety springs compressing, but no movement of the transmitting portion of the action slider will occur.

From the positions shown in FIGS. 22A and 22B the touch bar assembly may detect that the touch bar has been depressed and enter delayed egress mode. In one embodiment this may simply result in release of the brake after a period of time. After which, a user pushing the touch bar 204 will be able to move the action slider (transmitting portion) towards the motor. The slots or guide will push the linear actuator turning the motor rod. The angle and pitch of the thread on the motor rod is set so that pushing of the linear actuator turns the rod. The linear actuator will be pushed to the position shown in FIGS. 20A and 20B which is the retracted position.

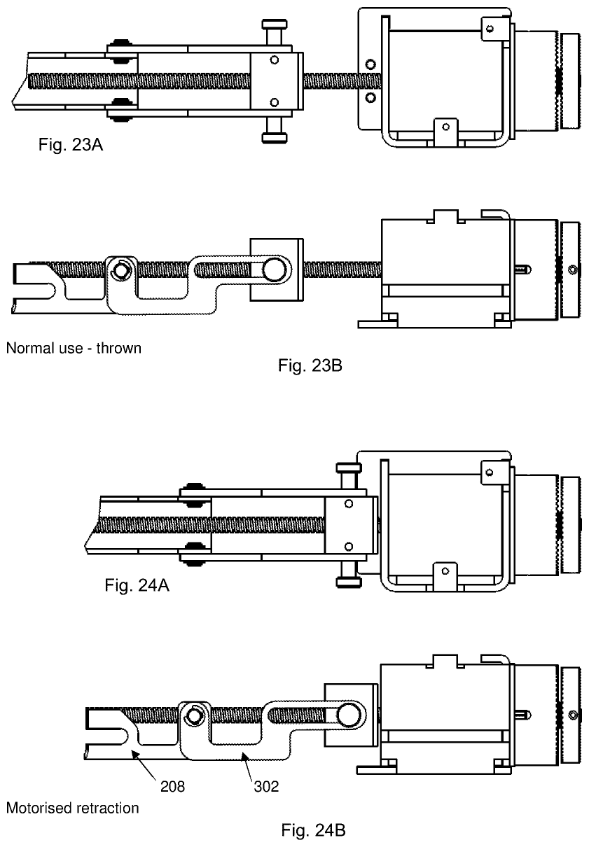

Alternatively, on release of the brake in delayed egress mode, the motor may be driven to move the linear actuator to the neutral position shown in FIGS. 19A and 19B and 23A and 23 B. (FIG. 23A and 23B are the same as FIGS. 19A and 19B but are provided adjacent to FIGS. 24A and 24B for ease of comparison.) In this position the motor may continue to retract the linear actuator pulling the action slider to retract the bolts and the touch bar 204. The linear actuator in this retracted position is shown in FIGS. 24A and 24B. Here it can be seen that action slider 208 and coupling 302 are moved close to the motor. The action slider and coupling are in the same retracted position as shown in FIGS. 20A and 20B for manual retraction. However, as they have been pulled there by the linear actuator driven by motor, the linear actuator is at the second end of the guides or slot in coupling 302.

As a combination between the alternatives of manual retraction or motorised retraction, the motor may move the action slider and linear actuator to the neutral position shown in FIGS. 19 and 23 ready for the user to push the touch bar to retract the bolts. The approach of motorised retraction to retract the bolts may be used where it is important to release the bolts and door after a period of time. For example, this may be in a safety critical situation in which the doors must be released as soon as possible. Manual retraction of the bolts from the neutral position, such as after release from the blocked position may be slower and requires the user to push the touch bar again having being refused exit on the first time of pushing. As discussed, manual retraction may require the user to push the linear actuator from the position shown in FIGS. 21A and 21B once the brake has been released. However, it may be preferable to use the motor to move the linear actuator to the neutral position because manual pushing of the linear actuator to the neutral position may have some resistance which slows the user exit. Such a delay would be less likely if the motor is used to move the linear actuator to the neutral position.

The motor and brake arrangement of the embodiment of FIGS. 15 to 24 consumes less power when the brake is turned on than the preceding embodiments. Furthermore, the restraining force is also sufficient to hold the (transmitting portion of the) action slider from moving when the touch bar is depressed and the safety springs are under pressure.

With reference to FIGS. 16 and 18 we described a motor assembly with brake. The applicant considers that the motor assembly and brake may have applications outside of the touch bar assembly described herein. For example, the motor assembly may find other applications in the bolting and security areas such as where motorised retraction of a bolt is performed using a rotor. Alternatively, the rotation of the motor rod may be used to control other aspects. In these various alternatives use outside of the touch bar assembly the motor rod may be a spindle without a thread. In one arrangement a motorised keep for receiving a bolt may be provided. The motorised keep may be for mounting in a door frame for receiving a bolt. In some arrangements it is desirable that instead of the bolt retracting, the keep release or rotates to free the bolt. Such lockable rotation of the keep may be provided by a motor assembly with brake described herein. As discussed the motor assembly with brake may comprise a motor having a spindle and a brake. The brake comprises electromagnet such as 320 in FIG. 16 and a rotor such as 326 in FIG. 16. The rotor may be coupled to the spindle for rotation with the spindle. The rotor should be ferromagnetic or other material to be attracted by the electromagnet. The rotor has teeth 326a. Second teeth are fixedly arranged facing the first teeth in an axial direction of the motor. Second teeth may be provided on a sleeve of electromagnet. As discussed above, the brake may be arranged such that on energising or de-energising the electromagnet the rotor is pulled towards the electromagnet and the first teeth engage with the second teeth stopping rotation of the rotor and spindle. The spindle or motor rod may extend from a first side of a motor for rotational driving to a second side of the motor where the rotor is coupled to the spindle.

As discussed in relation to FIG. 16, the motor may be a stepper mode and the coils of the motor may be used as a brake. However, such brakes are not strong and the teeth provide a much greater braking or restraining force.

In one embodiment the teeth in the rotor and sleeve may be formed by stamping or pressing the teeth. This requires a stamping or press die to be made. The rotor and sleeve may be stamped or pressed to include the teeth. If needed, a secondary part may be stamped or pressed with teeth and then fixed to the rotor or sleeve. Stamping or pressing is advantageous over machining, such as milling, because it is difficult to machine the sloped surfaces with small features. Casting may also be used in forming the teeth.

The person skilled in the art will readily appreciate that various modifications and alterations may be made to the above described methods and apparatus. The parts may take different forms and sizes from those shown. Alternative biasing or spring means may be provided and the precise locations of parts in the assembly may be changed. The modifications may be made without departing from the scope of the appended claims.

Embodiments of the present invention are provided in the following clauses:
Clause A1. A touch bar assembly for releasing a bolt, the touch bar assembly comprising:
a touch bar for actuation by a user;
an action slider coupled to the touch bar for retracting the bolt;
a motor arranged to drive a motor rod between a retracted position, a neutral position and a blocking position, the motor rod coupled to the action slider by a coupling comprising a gate,
wherein movement of the motor rod from the neutral position to the blocking position moves the gate to a blocking configuration blocking retraction of the action slider, and
the coupling couples motion of the motor rod from the neutral position to the retracted position into retraction of the action slider to retract the bolt.
Clause A2. The touch bar assembly of clause A1, wherein movement of the motor rod from the blocking position to the neutral position moves the gate to an open position releasing the action slider for retraction of the bolt.
Clause A3. The touch bar assembly of clause A1 or clause A2, wherein the motor comprises a brake to prevent movement of the motor rod when in the blocking position.
Clause A4. The touch bar assembly of clause A3, wherein the gate is arranged such that in the blocking configuration a force on the action slider resulting from a force applied to the touch bar is reduced by the gate to reduce the force transmitted from the action slider to the motor rod.
Clause A5. The touch bar assembly of any of clauses A1-A4, wherein the gate comprises a stopping bar, the gate configured such that in the blocking configuration the stopping bar blocks movement of the action slider.
Clause A6. The touch bar assembly of clause A5, wherein the stopping bar slides in a slot and is biased away from a blocking configuration.
Clause A7. The touch bar assembly of clause A6, wherein the action slider is configured to move in a first direction as its retracts the bolt, the slot restricts the direction of movement of the stopping bar and is angled to be less than 90° transverse to the first direction.
Clause A8. The touch bar assembly of clause A7, wherein the slot is angled between 60 and 85°, or more preferably between 70° and 80°, or even more preferably around 75°, transverse to the first direction.
Clause A9. The touch bar assembly of any of clauses A5 to A8, wherein the action slider comprises a blocking surface against which the stopping bar bears in the blocking configuration.
Clause A10. The touch bar assembly of any of clauses A5 to A9, wherein the coupling comprises a carriage coupled to the motor rod and the action slider, the carriage having a driving surface arranged such that on moving the motor rod to the blocking configuration the driving surface bears against the stopping bar to move the gate to a blocking configuration.
Clause A11. The touch bar assembly of clause A10, wherein the driving surface is a ramp surface arranged to pull the stopping bar down to block retraction of the action slider as the motor rod pushes the carriage and moves to the blocking position.
Clause A12. The touch bar assembly of clause A11, wherein the ramp surface has an angle of between 25° and 45° to the movement direction of the action slider.
Clause A13. The touch bar assembly of clause A12, wherein the ramp surface has an angle of between 30° and 40°, or more preferably around 35° to the movement direction of the action slider.
Clause A14. The touch assembly of any of clauses A10 to A13, wherein the carriage couples motion of the motor rod from the neutral position to the retracted position to pull on the action slider to retract the bolt.
Clause A15. The touch assembly of any of clauses A10 to A14, wherein the coupling is configured with lost motion between the carriage and the action slider such that movement of the action slider by actuation of the touch bar does not move the motor rod.
Clause A16. The touch assembly of clause A14, wherein the lost motion is provided by a rod of the carriage moving in a slot of the action slider.
Clause A17. The touch assembly of any of clauses A10 to A16, wherein the carriage comprises a channel in which the action slider extends.
Clause A18. The touch bar assembly of any of clauses A10 to A17, wherein the motor rod is biased to move from the blocking position to the neutral position.
Clause A19. The touch bar assembly of any of clauses A1-A19, wherein the action slider is coupled to the touch bar by cranks, the cranks configured such that on pushing the touch bar the cranks rotate to translate the action slider.
Clause A20. The touch bar assembly of any of clauses A1-A20, wherein the action slider comprises a receiving portion coupled to the touch bar to receive a driving force from a user applied at the touch bar, the action slider further comprises a transmitting portion coupled to the coupling for movement by the motor rod, and wherein the action slider comprises one of more safety springs between the receiving portion and transmitting portion, the safety springs arranged to absorb the user force when the gate is in the blocking configuration.
Clause A21. The touch bar assembly of any of clauses Al-A20, further comprising the bolt or a bolting mechanism including the bolt.
Clause B22. A door comprising the touch bar assembly of any of clauses A1-A21.

What is claimed:

1-62. (canceled)

63. A touch bar assembly for releasing a bolt, the touch bar assembly comprising:
a touch bar for actuation by a user;
an action slider coupled to for retracting the bolt;
a motor arranged to drive a linear actuator between a retracted position, a neutral position and a blocking position, the linear actuator coupled to the action slider by a coupling,
wherein the linear actuator and coupling are configured such that in the blocking position retraction of the action slider is blocked, and
the coupling couples motion of the linear actuator from the neutral position to the retracted position into retraction of the action slider to retract the bolt.

64. The touch bar assembly of claim 63, wherein movement of the linear actuator from the blocking position to the neutral position releases the action slider for retraction of the bolt.

65. The touch bar assembly of claim 63, wherein the coupling and linear actuator are configured with lost motion there between such that, when the linear actuator is at the neutral position, movement of the action slider by actuation of the touch bar does not move the linear actuator.

66. The touch bar assembly of claim 63, wherein the motor comprises a spindle having at least a threaded portion and the motor is configured to rotate the spindle to drive movement of the linear actuator.

67. The touch bar assembly of claim 66, wherein the linear actuator comprises a threaded portion, the linear actuator arranged to move along a linear path when the motor rotates the spindle.

68. The touch bar assembly of claim 67, wherein the coupling comprises one or more guides or slots into which the linear actuator extends for guiding or blocking retraction of the bolt.

69. The touch bar of claim 63, wherein the action slider comprises the coupling.

70. The touch bar assembly of claim 63, further comprising one or more brakes to stop rotation of the spindle of the motor.

71. The touch bar assembly of claim 70, wherein a first brake of the one or more brakes comprises:
an electromagnet;
a rotor coupled to the spindle for rotation with the spindle, the rotor being ferromagnetic and having first teeth; and
second teeth fixedly arranged facing the first teeth in an axial direction of the motor,
wherein the brake is arranged such that on energizing or de-energizing the electromagnet the rotor is pulled towards the second teeth and the first teeth engage with the second teeth stopping rotation of the rotor and spindle.

72. The touch bar assembly of claim 71, wherein the rotor is biased away from the second teeth.

73. The touch bar assembly of claim 71, wherein the electromagnet is annular and arranged with the spindle passing there through, and the second teeth are arranged on a tubular sleeve around the electromagnet.

74. The touch bar assembly of claim 71, wherein the first teeth and/or second teeth are formed with sides at 45°.

75. The touch bar assembly of claim 70, wherein the motor is a stepper motor comprising a second brake.

76. The touch bar assembly of claim 63, wherein the action slider is coupled to the touch bar by cranks, the cranks configured such that on pushing the touch bar the cranks rotate to translate the action slider.

77. The touch bar assembly of claim 63, wherein the action slider comprises a receiving portion coupled to the touch bar to receive a driving force from a user applied at the touch bar, the action slider further comprises a transmitting portion coupled to the coupling for movement by the linear actuator, and wherein the action slider comprises one of more safety springs between the receiving portion and transmitting portion, the safety springs arranged to absorb the user force when the linear actuator is in the blocking position.

78. The touch bar assembly of claim 63, further comprising the bolt or a bolting mechanism including the bolt.

79. A door comprising the touch bar assembly of claim 63.

80. A touch bar assembly for releasing a bolt, the touch bar assembly comprising:
a touch bar for actuation by a user;
an action slider coupled to the touch bar for retracting the bolt;
a motor arranged to drive a motor rod between a retracted position, a neutral position and a blocking position, the motor rod coupled to the action slider by a coupling comprising a gate,
wherein movement of the motor rod from the neutral position to the blocking position moves the gate to a blocking configuration blocking retraction of the action slider, and
the coupling couples motion of the motor rod from the neutral position to the retracted position into retraction of the action slider to retract the bolt.

81. The touch bar assembly of claim 80, further comprising the bolt or a bolting mechanism including the bolt.

82. A door comprising the touch bar assembly of claim 80.

83. A motor assembly with brake, the assembly comprising:
the motor having a spindle; and
the brake comprising:
an electromagnet;
a rotor coupled to the spindle for rotation with the spindle, the rotor being ferromagnetic and having first teeth; and
second teeth fixedly arranged, the second teeth facing the first teeth in an axial direction of the motor,
wherein the brake is arranged such that on energizing or de-energizing the electromagnet the rotor is pulled towards the electromagnet and the first teeth engage with the second teeth stopping rotation of the rotor and spindle.

84. The motor assembly of claim 83, wherein the spindle extends from a first side of a motor for rotational driving to a second side of the motor where the rotor is coupled to the spindle.

85. The motor assembly of claim 83, wherein the teeth are formed in at least part of a circle in proximity to the electromagnet.

86. The motor assembly of claim 83, wherein the electromagnetic is arranged around the spindle at the second side of the motor.

87. The motor assembly of claim 83, wherein the rotor is a disc and the second teeth are arranged around a circumference of the electromagnet.

88. The motor assembly of claim 87, further comprising a tube, pipe or sleeve around the electromagnet and the second teeth arranged at the end of the tube or pipe.

89. The motor assembly of claim 83, wherein the first teeth and/or second teeth are formed with sides at 45°.

90. The motor assembly of claim 83, wherein the teeth are formed by stamping, pressing, casting or machining.

91. The motor assembly of claim 83, wherein the motor is a stepper motor, wherein the brake is a first brake and the stepper motor comprises a second brake.

92. The motor assembly of claim 83, wherein the spindle is a rod having at least a portion that is threaded extending from the first side of the motor.

93. The motor assembly of claim 92, further comprising a linear actuator having a threaded hole, the threaded portion of the spindle arranged to extend therethrough, and the linear actuator arranged such that on rotation of the spindle the linear actuator moves linearly.
